(19) United States
(12) Patent Application Publication
(10) Pub. No.: US 2020/0265061 A1
(43) Pub. Date: Aug. 20, 2020

(54) SIGNAL NORMALIZATION, EVENT DETECTION, AND EVENT NOTIFICATION USING AGENCY CODES

(71) Applicant: Banjo, Inc., South Jordan, UT (US)

(72) Inventors: Christian Gratton, Las Vegas, NV (US); Damien Patton, Park City, UT (US); Travis W. Carter, Las Vegas, NV (US); Ashley Patricia Gates, Salt Lake City, UT (US); Colby Tibbet, Salt Lake City, UT (US)

(21) Appl. No.: 16/806,423

(22) Filed: Mar. 2, 2020

Related U.S. Application Data
(63) Continuation-in-part of application No. 16/029,481, filed on Jul. 6, 2018.
Application No. 16/029,481 is a continuation-in-part of application No. 16/396,454, filed on Apr. 26, 2019.
Application No. 16/396,454 is a continuation of application No. 16/038,537, filed on Jul. 18, 2018, now Pat. No. 10,324,948.
Application No. 16/038,537 is a continuation-in-part of application No. 16/511,720, filed on Jul. 15, 2019, now Pat. No. 10,552,683.
Application No. 16/511,720 is a continuation of application No. 16/285,031, filed on Feb. 25, 2019, now Pat. No. 10,404,840.
Application No. 16/285,031 is a continuation-in-part of application No. 16/106,436, filed on Aug. 21, 2018, now Pat. No. 10,257,058.
Application No. 16/106,436 is a continuation-in-part of application No. 16/560,328, filed on Sep. 4, 2019.
Application No. 16/560,328 is a continuation-in-part of application No. 16/390,297, filed on Apr. 22, 2019, now Pat. No. 10,447,750.
Application No. 16/390,297 is a continuation of application No. 16/101,208, filed on Aug. 10, 2018, now Pat. No. 10,313,413.
(60) Provisional application No. 62/654,274, filed on Apr. 6, 2018.
(60) Provisional application No. 62/654,277, filed on Apr. 6, 2018.
(60) Provisional application No. 62/664,001, filed on Apr. 27, 2018.
(60) Provisional application No. 62/682,176, filed on Jun. 8, 2018.
(60) Provisional application No. 62/682,177, filed on Jun. 8, 2018.
(60) Provisional application No. 62/664,001, filed on Apr. 27, 2018.
(60) Provisional application No. 62/667,616, filed on May 7, 2018.
(60) Provisional application No. 62/686,791, filed on Jun. 19, 2018.
(60) Provisional application No. 62/664,001, filed on Apr. 27, 2018.
(60) Provisional application No. 62/667,616, filed on May 7, 2018.
(60) Provisional application No. 62/685,814, filed on Jun. 15, 2018.
(60) Provisional application No. 62/686,791, filed on Jun. 19, 2018.
(60) Provisional application No. 62/691,806, filed on Jun. 29, 2018.
(60) Provisional application No. 62/550,797, filed on Aug. 28, 2017.
(60) Provisional application No. 62/812,551, filed on Mar. 1, 2019.
(60) Provisional application No. 62/954,129, filed on Dec. 27, 2019.
(60) Provisional application No. 62/979,230, filed on Feb. 20, 2020.

(51) Int. Cl. G06F 16/25; G06F 16/28

(52) U.S. Cl. CPC G06F 16/254; G06F 16/285

(57) ABSTRACT

The present invention extends to methods, systems, and computer program products for signal normalization, event detection, and event notification using agency codes. Ingestion modules can ingest different types of raw structured and/or raw unstructured signals on an ongoing basis and possibly including agency codes. The signal ingestion modules normalize raw signals into normalized signals having a Time, Location, Context (or “TLC”) dimensions. An event detection infrastructure determines that characteristics of multiple signals, possibly including agency codes, when considered in combination, indicate an event of interest to one or more parties. Agency codes associated with events can be translated between agency code languages and/or between different agencies/jurisdictions.

### CROSS-REFERENCE TO RELATED APPLICATIONS

This application claims the benefit of U.S. Provisional Patent Application Ser. No. 62/812,551, entitled “Incident Type Mapping”, filed Mar. 1, 2019 which is incorporated herein in its entirety. This application claims the benefit of U.S. Provisional Patent Application Ser. No. 62/954,129, entitled “Incident Type Mapping”, filed Dec. 27, 2019, which is incorporated herein in its entirety.

This application claims the benefit of U.S. Provisional Patent Application Ser. No. 62/979,230, entitled “Identifying Related Signals Using Dimensionally Reduced Signal Representations”, filed Feb. 20, 2020, which is incorporated herein in its entirety.

This application is a continuation in part of U.S. patent application Ser. No. 16/029,481, entitled “Detecting Events From Features Derived From Multiple Ingested Signals” filed Jul. 6, 2018, which is incorporated herein in its entirety. That application claims the benefit of U.S. Provisional Patent Application Ser. No. 62/654,274, entitled “Detecting Events From Multiple Signals”, filed Apr. 6, 2018 which is incorporated herein in its entirety. That application claims the benefit of U.S. Provisional Patent Application Ser. No. 62/654,277 entitled, “Validating Possible Events With Additional Signals”, filed Apr. 6, 2018 which is incorporated herein in its entirety. That application claims the benefit of U.S. Provisional Patent Application Ser. No. 62/664,001, entitled, “Normalizing Different Types Of Ingested Signals Into A Common Format”, filed Apr. 27, 2018. That application claims the benefit of U.S. Provisional Patent Application Ser. No. 62/682,176 entitled “Detecting An Event From Multiple Sources”, filed Jun. 8, 2018 which is incorporated herein in its entirety. That application claims the benefit of U.S. Provisional Patent Application Ser. No. 62/682,177 entitled “Detecting An Event From Multi-Source Event Probability”, filed Jun. 8, 2018 which is incorporated herein in its entirety.

This application is a continuation in part of U.S. patent application Ser. No. 16/396,454, entitled “Normalizing Ingested Signals” filed Apr. 26, 2019, which is incorporated herein in its entirety. That application is a continuation of U.S. patent application Ser. No. 16/038,537, now U.S. Pat. No. 10,324,948, entitled “Normalizing Ingested Signals”, filed Jul. 18, 2018 which is incorporated herein in its entirety. That application claims the benefit of U.S. Provisional Patent Application Ser. No. 62/664,001, entitled “Normalizing Different Types Of Ingested Signals Into A Common Format”, filed Apr. 27, 2018 which is incorporated herein in its entirety. That application claims the benefit of U.S. Provisional Patent Application Ser. No. 62/667,616, entitled “Normalizing Different Types Of Ingested Signals Into A Common Format”, filed May 7, 2018 which is incorporated herein in its entirety. That application claims the benefit of U.S. Provisional Patent Application Ser. No. 62/686,791 entitled, “Normalizing Signals”, filed Jun. 19, 2018 which is incorporated herein in its entirety.

This application is a continuation in part of U.S. patent application Ser. No. 16/741,369, entitled “Ingesting Streaming Signals” filed Jan. 13, 2020, which is incorporated herein in its entirety. That application is a continuation in part of U.S. patent application Ser. No. 16/511,720, now U.S. Pat. No. 10,552,683, entitled “Ingesting Streaming Signals” filed Jul. 15, 2019, which is incorporated herein in its entirety. That application is a continuation of U.S. patent application Ser. No. 16/285,031, now U.S. Pat. No. 10,404,840, entitled “Ingesting Streaming Signals,” filed Feb. 25, 2019, which is incorporated herein in its entirety. That application is a continuation in part of U.S. patent application Ser. No. 16/106,436, now U.S. Pat. No. 10,257,058, entitled “Ingesting Streaming Signals”, filed Aug. 21, 2018, which is incorporated herein in its entirety. That application claims the benefit of U.S. Provisional Patent Application Ser. No. 62/664,001, entitled “Normalizing Different Types Of Ingested Signals Into A Common Format”, filed Apr. 27, 2018. That application claims the benefit of U.S. Provisional Patent Application Ser. No. 62/667,616, entitled “Normalizing Different Types Of Ingested Signals Into A Common Format”, filed May 7, 2018. That application claims the benefit of U.S. Provisional Patent Application Ser. No. 62/685,814, entitled “Ingesting Streaming Signals”, filed Jun. 15, 2018. That application claims the benefit of U.S. Provisional Patent Application Ser. No. 62/686,791, entitled, “Normalizing Signals”, filed Jun. 19, 2018. That application claims the benefit of U.S. Provisional Patent Application Ser. No. 62/691,806, entitled “Ingesting Streaming Signals”, filed Jun. 29, 2018, each of which are incorporated herein in their entirety.

This application is a continuation in part of U.S. patent application Ser. No. 16/560,328, entitled “Detecting An Event From Signal Data” filed Sep. 4, 2019, which is incorporated herein in its entirety. That application is a continuation in part of U.S. patent application Ser. No. 16/390,297, now U.S. Pat. No. 10,447,750, entitled “Detecting Events From Ingested Communication Signals”, filed Apr. 22, 2019 which is incorporated herein in its entirety. That application is a Continuation of U.S. patent application Ser. No. 16/101,208, now U.S. Pat. No. 10,313,413, entitled “Detecting Events From Ingested Communication Streams”, filed Aug. 10, 2018 which is incorporated herein in its entirety. That application claims the benefit of U.S. Provisional Patent Application Ser. No. 62/550,797, entitled “Event Detection System and Method”, filed Aug. 28, 2017 which is incorporated herein in its entirety.

### BACKGROUND

### 1. Background and Relevant Art

First responders desire to be made aware of relevant events as close as possible to the events' occurrence (i.e., as close as possible to “moment zero”). Relevancy of an event depends in part on location, context, truthfulness, and severity.

Responding to some events can include interagency cooperation. For example, one municipal or county law enforcement agency may assist another municipal or county law enforcement agency. In another example, a municipal or county law enforcement agency may assist a state or federal law enforcement agency or vice versa. At times, the cooperation may occur ad hoc and with little, if any, prior notice. As examples, a suspect attempting to flee in a motor vehicle may cross jurisdictional boundaries (e.g., a city, county, or state line), a unit from one jurisdiction may respond to an “officer needs assistance” call from a unit in another jurisdiction, etc.

### BRIEF SUMMARY

Examples extend to methods, systems, and computer program products for signal normalization, event detection, and event notification using agency codes.

In general, signal ingestion modules ingest different types of raw structured and unstructured signals on an ongoing basis. The signal ingestion modules normalize raw signals into normalized signals having a Time, Location, Context (or “TLC”) format. Time can be a time of origin or “event time” of a signal. Location can be anywhere across a geographic area, such as, a country (e.g., the United States), a State, a defined area, an impacted area, an area defined by a geo cell, an address, etc.

Context indicates circumstances surrounding formation/origination of a raw signal in terms that facilitate understanding and assessment of the raw signal. The context of a raw signal can be derived from express as well as inferred signal features of the raw signal. Context can include agency codes in a code language associated with an agency/jurisdiction.

Signal ingestion modules can include one or more single source classifiers. A single source classifier can compute a single source probability for a raw signal from (inferred and/or express) signal features of the raw signal. A single source probability can reflect a mathematical probability or approximation of a mathematical probability of an event (e.g., fire, accident, weather, police presence, etc.) actually occurring. A single source classifier can be configured to compute a single source probability for a single event type or to compute a single source probability for each of a plurality of different event types.

As such, single source probabilities and corresponding probability details can represent Context. Probability details can indicate (e.g., can include a hash field indicating) a probability version and (express and/or inferred) signal features considered in a signal source probability calculation.

Concurrently with signal ingestion, an event detection infrastructure considers features of different combinations of normalized signals to attempt to identify events of interest to various parties. For example, the event detection infrastructure can determine that features of multiple different signals collectively indicate an event of interest to one or more parties. Alternately, the event detection infrastructure can determine that features of one or more signals indicate a possible event of interest to one or more parties. The event detection infrastructure then determines that features of one or more other signals validate the possible event as an actual event of interest to the one or more parties. Signal features can include: signal type, signal source, signal content, signal time (T), signal location (L), signal context (C), other circumstances of signal creation, an indication of agency/jurisdiction, one or more agency codes, etc.

The event detection infrastructure can group signals having sufficient temporal similarity and sufficient spatial similarity to one another in a signal sequence. In one aspect, any signal having sufficient temporal and spatial similarity to another signal can be added to a signal sequence.

In another aspect, a single source probability for a signal is computed from features of the signal. The single source probability can reflect a mathematical probability or approximation of a mathematical probability of an event actually occurring. A signal having a signal source probability above a threshold can be indicated as an “elevated” signal. Elevated signals can be used to initiate and/or can be added to a signal sequence. On the other hand, non-elevated signals may not be added to a signal sequence.

A multi-source probability can be computed from features of multiple normalized signals, including normalized signals in a signal sequence. Features used to compute a multi-source probability can include multiple single source probabilities as well as other features derived from multiple signals. The multi-source probability can reflect a mathematical probability or approximation of a mathematical probability of an event actually occurring based on multiple normalized signals (e.g., a signal sequence). A multi-source probability can change over time as normalized signals age or when a new normalized signal is received (e.g., added to a signal sequence).

Agency codes can be converted between code languages so that agencies/jurisdictions can view events in association with their own agency codes.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by practice. The features and advantages may be realized and obtained by means of the instruments and combinations particularly pointed out in the appended claims. These and other features and advantages will become more fully apparent from the following description and appended claims, or may be learned by practice as set forth hereinafter.

### BRIEF DESCRIPTION OF THE DRAWINGS

In order to describe the manner in which the above-recited and other advantages and features can be obtained, a more particular description will be rendered by reference to specific implementations thereof which are illustrated in the appended drawings. Understanding that these drawings depict only some implementations and are not therefore to be considered to be limiting of its scope, implementations will be described and explained with additional specificity and detail through the use of the accompanying drawings in which:

FIG. 1A illustrates an example computer architecture that facilitates normalizing ingesting signals.

FIG. 1B illustrates an example computer architecture that facilitates detecting events from normalized signals.

FIG. 2 illustrates a flow chart of an example method for normalizing ingested signals.

FIGS. 3A, 3B, and 3C illustrate other example components that can be included in signal ingestion modules.

FIG. 4 illustrates a flow chart of an example method for normalizing an ingested signal including time information, location information, and context information.

FIG. 5 illustrates a flow chart of an example method for normalizing an ingested signal including time information and location information.

FIG. 6 illustrates a flow chart of an example method for normalizing an ingested signal including time information.

FIG. 7 illustrates an example computer architecture that facilitates detecting an event from features derived from multiple signals.

FIG. 8 illustrates a flow chart of an example method for detecting an event from features derived from multiple signals.

FIG. 9 illustrates an example computer architecture that facilitates detecting an event from features derived from multiple signals.

FIG. 10 illustrates a flow chart of an example method for detecting an event from features derived from multiple signals

FIG. 11A illustrates an example computer architecture that facilitates forming a signal sequence.

FIG. 11B illustrates an example computer architecture that facilitates detecting an event from features of a signal sequence.

FIG. 11C illustrates an example computer architecture that facilitates detecting an event from features of a signal sequence.

FIG. 11D illustrates an example computer architecture that facilitates detecting an event from a multisource probability.

FIG. 11E illustrates an example computer architecture that facilitates detecting an event from a multisource probability.

FIG. 12 illustrates a flow chart of an example method for forming a signal sequence.

FIG. 13 illustrates a flow of an example method for detecting an event from a signal sequence.

### DETAILED DESCRIPTION

Examples extend to methods, systems, and computer program products for signal normalization, event detection, and event notification using agency codes.

First responders can use a set of dispatch codes, disposition codes, action codes, informational codes, incident codes, brevity codes, etc. (e.g., “11” codes, “10” codes, “9” codes, 900 series codes, other numeric codes, letter codes (e.g., A, B, C etc.), combination numerical/letter codes, etc.) to minimize radio channel usage. However, each jurisdiction/agency (law enforcement, fire, ambulance, public safety, aviation administration, military, etc.) typically sets the meaning of their own code. As such, there is often a lack of code uniformity across jurisdictions/agencies.

A number of difficulties arise due to lack of code uniformity. The same code can have different meanings across different jurisdictions (e.g., between different police departments). For example, 10-50 may mean “traffic accident” in one jurisdiction and 10-50 may mean “frequency change” in another jurisdiction. A code may be used in one jurisdiction and not used in another jurisdiction. Additionally, different jurisdictions can use different codes to represent essentially the same meaning of a situation. For example, one jurisdiction can use 10-54 to represent “Traffic Control” and another jurisdiction can used 11-84 to represent “Direct Traffic”.

Appropriate interjurisdictional/interagency cooperation can be hampered due to mismatches in codes across different jurisdictions/agencies. For example, units of one jurisdiction/agency can misinterpret an incident based on codes used by units of another jurisdiction/agency. Incident misinterpretation can result in an inappropriate response. For example, emergency equipment may be activated when responding to a very minor incident or emergency equipment may not be activated when responding to an incident with the potential to result in bodily harm or death.

Mismatches in codes across different jurisdictions/agencies can also hamper subsequent information sharing across jurisdictions/agencies. For example, personnel at one agency may listen to radio traffic associated with another agency responding to an incident. However, the personnel may have to reference code documentation for the other agency to discern the actual meaning of the incident.

Aspects of the invention provide (e.g., real-time) translation of incident types across differing agency code languages. Translation of incident types enables better collaboration across agencies that use different languages to classify their incident types. Codes corresponding to a jurisdiction can be translated into a common code base (e.g., plain language). Information from the common code base can then be translated back to codes corresponding to the jurisdiction or to codes corresponding to a different jurisdiction. A user interface can be used to display one or more of: an original code corresponding to a jurisdiction, a common code base (e.g., plain language) meaning, and a translated code corresponding to another jurisdiction.

A language can be provided in a (e.g., live-time) events architecture that has a number of agency's native language (codes) mapped to the common code base (e.g., plain language). These mappings facilitate translation between agencies that use different codes. As such, an event can be identified based on a code of one agency. The code can be translated to a code of another agency. The event can then be presented to the other agency. Since the event is presented with the translated code (i.e., the code of the other agency), the other agency can more efficiently and effectively understand aspects of event.

Implementations can comprise or utilize a special purpose or general-purpose computer including computer hardware, such as, for example, one or more computer and/or hardware processors (including any of Central Processing Units (CPUs), and/or Graphical Processing Units (GPUs), general-purpose GPUs (GPGPUs), Field Programmable Gate Arrays (FPGAs), application specific integrated circuits (ASICs), Tensor Processing Units (TPUs)) and system memory, as discussed in greater detail below. Implementations also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations can comprise at least two distinctly different kinds of computer-readable media: computer storage media (devices) and transmission media.

Computer storage media (devices) includes RAM, ROM, EEPROM, CD-ROM, Solid State Drives (“SSDs”) (e.g., RAM-based or Flash-based), Shingled Magnetic Recording (“SMR”) devices, Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

In one aspect, one or more processors are configured to execute instructions (e.g., computer-readable instructions, computer-executable instructions, etc.) to perform any of a plurality of described operations. The one or more processors can access information from system memory and/or store information in system memory. The one or more processors can (e.g., automatically) transform information between different formats, such as, for example, between any of: raw signals, normalized signals, signal features, times, time dimensions, locations, location dimensions, geo cells, geo cell entries, designated market areas (DMAs), contexts, location annotations, context annotations, classification tags, context dimensions, single source probabilities, possible events, events, signal sequences, signal sequence features, multisource probabilities, agencies, agency code languages, agency codes, a common language, etc.

System memory can be coupled to the one or more processors and can store instructions (e.g., computer-readable instructions, computer-executable instructions, etc.) executed by the one or more processors. The system memory can also be configured to store any of a plurality of other types of data generated and/or transformed by the described components, such as, for example, raw signals, normalized signals, signal features, times, time dimensions, locations, location dimensions, geo cells, geo cell entries, designated market areas (DMAs), contexts, location annotations, context annotations, classification tags, context dimensions, single source probabilities, possible events, events, signal sequences, signal sequence features, multisource probabilities, agencies, agency code languages, agency codes, a common language, etc.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, in response to execution at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the described aspects may be practiced in network computing environments with many types of computer system configurations, including, personal computers, desktop computers, laptop computers, message processors, hand-held devices, wearable devices, multicore processor systems, multi-processor systems, microprocessor-based or programmable consumer electronics, network PCs, minicomputers, mainframe computers, mobile telephones, PDAs, tablets, routers, switches, and the like. The described aspects may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more Field Programmable Gate Arrays (FPGAs) and/or one or more application specific integrated circuits (ASICs) and/or one or more Tensor Processing Units (TPUs) can be programmed to carry out one or more of the systems and procedures described herein. Hardware, software, firmware, digital components, or analog components can be specifically tailor-designed for a higher speed detection or artificial intelligence that can enable signal processing. In another example, computer code is configured for execution in one or more processors, and may include hardware logic/electrical circuitry controlled by the computer code. These example devices are provided herein purposes of illustration, and are not intended to be limiting. Embodiments of the present disclosure may be implemented in further types of devices.

The described aspects can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources (e.g., compute resources, networking resources, and storage resources). The shared pool of configurable computing resources can be provisioned via virtualization and released with low effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the following claims, a “cloud computing environment” is an environment in which cloud computing is employed.

In this description and the following claims, an “agency code” is defined as a combination of numbers and/or letters used by an agency and indicating specific meanings, such as, identifying an incident or relaying information related to an incident (e.g., theft, robbery, injury, fire, unit status, call disposition, civil disturbance, ambulance needed, in service, accident shooting, etc.). Agencies (including first responders) can use various agency codes including, but not limited to, incident codes, dispatch codes, disposition codes, action codes, informational codes, brevity codes, protocol codes, weather codes, medical codes, signals, clearing codes, maritime codes, aviation codes, etc. Codes can include “11” codes (e.g., 11-12, etc.), “10” codes (e.g., 10-82, 10-10-0, 10-27-4, 10-15B, etc.), “9” codes (9-05, 9-27, etc.), 900 series codes (910A, 946, etc.), other numeric codes (3310, 5-4, 23104, 191.5, etc.), letter/word codes (e.g., A, B, C, DG, BBC, Code J, Code Orange, etc.), combination numerical and letter/word codes (e.g., 1-D-1, 77-D-3, 25A, 10-15B, 418G, 484PS, 647(f), 22348(b), “Level 1”, “Signal 7”, “Code 5”, 14VCO, F13, F24D, IC4, etc.), abbreviations (e.g., D.O.A., D.O.B., etc.), etc.

Stating an agency code in radio communication can indicate a corresponding specific meaning to others listening to the radio communication. As such, codes can be used to relay a specified meaning in a manner that minimizes radio traffic. That is, stating a code can be more efficient (and takes less time “on air”) than expressly stating a specified meaning corresponding to the agency code. An agency code can also be recorded in written form to reduce the length of documents and present specified meanings more efficiently.

In this description and the following claims, an “agency code language” is defined a set of agency codes and corresponding specified meanings corresponding to an agency. The agency can use agency codes in the agency code language to communicate information between personnel via radio and written (and possibly other forms of) communication. An agency code language can include agency codes selected from among any of: incident codes, dispatch codes, disposition codes, action codes, informational codes, brevity codes, protocol codes, weather codes, medical codes, signals, clearing codes, maritime codes, aviation codes, etc.

In one aspect, each different agency has its own agency code language. Per agency, an agency code language can include one or more agency codes having agency specific meanings. In another aspect, a jurisdiction includes a plurality of agencies that used the same agency code language. For example, a police agency, a fire agency, and an ambulance agency associated with a municipality may use the same agency code language.

In this description and the following claims, a “common language” is defined as a language including assigned meanings that can be understood by a plurality of different agencies. A common language may or may not include codes. In one aspect, a common language includes event, incident, activity, etc., descriptions in plain text. Presenting signal information in a common language can provide one agency with a basic and fundamental understanding of an agency code language corresponding to another agency. Aspects of the invention include components configured to convert/translate agency codes into the common language (e.g., plain text).

In this description and the following claims, a “source code language” is defined as an agency code language associated with a (raw or normalized) signal's source.

In this description and the following claims, a “native code language” is defined as an agency's own agency code language (i.e., a user's own agency code language).

In this description and the following claims, a “geo cell” is defined as a piece of “cell” in a spatial grid in any form. In one aspect, geo cells are arranged in a hierarchical structure. Cells of different geometries can be used.

A “geohash” is an example of a “geo cell”.

In this description and the following claims, “geohash” is defined as a geocoding system which encodes a geographic location into a short string of letters and digits. Geohash is a hierarchical spatial data structure which subdivides space into buckets of grid shape (e.g., a square). Geohashes offer properties like arbitrary precision and the possibility of gradually removing characters from the end of the code to reduce its size (and gradually lose precision). As a consequence of the gradual precision degradation, nearby places will often (but not always) present similar prefixes. The longer a shared prefix is, the closer the two places are. geo cells can be used as a unique identifier and to approximate point data (e.g., in databases).

In one aspect, a “geohash” is used to refer to a string encoding of an area or point on the Earth. The area or point on the Earth may be represented (among other possible coordinate systems) as a latitude/longitude or Easting/Northing—the choice of which is dependent on the coordinate system chosen to represent an area or point on the Earth. Geo cell can refer to an encoding of this area or point, where the geo cell may be a binary string comprised of 0s and is corresponding to the area or point, or a string comprised of 0s, 1s, and a ternary character (such as X)—which is used to refer to a don't care character (0 or 1). A geo cell can also be represented as a string encoding of the area or point, for example, one possible encoding is base-32, where every 5 binary characters are encoded as an ASCII character.

Depending on latitude, the size of an area defined at a specified geo cell precision can vary. When geohash is used for spatial indexing, the areas defined at various geo cell precisions are approximately:

### Example Areas at Various Geo Cell Precisions

TABLE 1

| geo cell | |
|---|---|
| Length/Precision | width × height |
| 1 | 5,009.4 km × 4,992.6 km |
| 2 | 1,252.3 km × 624.1 km |
| 3 | 156.5 km × 156 km |
| 4 | 39.1 km × 19.5 km |
| 5 | 4.9 km × 4.9 km |
| 6 | 1.2 km × 609.4 m |
| 7 | 152.9 m × 152.4 m |
| 8 | 38.2 m × 19 m |
| 9 | 4.8 m × 4.8 m |
| 10 | 1.2 m × 59.5 cm |
| 11 | 14.9 cm × 14.9 cm |
| 12 | 3.7 cm × 1.9 cm |

Other geo cell geometries, such as, hexagonal tiling, triangular tiling, etc. are also possible. For example, the H3 geospatial indexing system is a multi-precision hexagonal tiling of a sphere (such as the Earth) indexed with hierarchical linear indexes.

In another aspect, geo cells are a hierarchical decomposition of a sphere (such as the Earth) into representations of regions or points based a Hilbert curve (e.g., the S2 hierarchy or other hierarchies). Regions/points of the sphere can be projected into a cube and each face of the cube includes a quad-tree where the sphere point is projected into. After that, transformations can be applied and the space discretized. The geo cells are then enumerated on a Hilbert Curve (a space-filling curve that converts multiple dimensions into one dimension and preserves the approximate locality).

Due to the hierarchical nature of geo cells, any signal, event, entity, etc., associated with a geo cell of a specified precision is by default associated with any less precise geo cells that contain the geo cell. For example, if a signal is associated with a geo cell of precision 9, the signal is by default also associated with corresponding geo cells of precisions 1, 2, 3, 4, 5, 6, 7, and 8. Similar mechanisms are applicable to other tiling and geo cell arrangements. For example, S2 has a cell level hierarchy ranging from level zero (85,011,012 km²) to level 30 (between 0.48 cm² to 0.96 cm²).

Signal Ingestion and Normalization

Signal ingestion modules can ingest a variety of raw structured and/or raw unstructured signals on an on going basis and in essentially real-time. Raw signals can include social posts, live broadcasts, traffic camera feeds, other camera feeds (e.g., from other public cameras or from CCTV cameras), listening device feeds, 911 calls, weather data, planned events, IoT device data, crowd sourced traffic and road information, satellite data, air quality sensor data, smart city sensor data, public radio communication (e.g., among first responders and/or dispatchers, between air traffic controllers and pilots), etc. The content of raw signals can include images, video, audio, text (including speech transcriptions), etc. Images, video, audio, text, etc. in (as well as other characteristics of) a raw signal may include and/or indicate an agency and/or one or more agency codes.

In general, signal normalization can prepare (or pre-process) raw signals into normalized signals to increase efficiency and effectiveness of subsequent computing activities, such as, event detection, event notification, etc., that utilize the normalized signals. For example, signal ingestion modules can normalize raw signals into normalized signals having a Time, Location, and Context (TLC) dimensions. An event detection infrastructure can use the Time, Location, and Content dimensions to more efficiently and effectively detect events.

Per signal type and signal content, different normalization modules can be used to extract, derive, infer, etc. Time, Location, and Context dimensions from/for a raw signal. For example, one set of normalization modules can be configured to extract/derive/infer Time, Location and Context dimensions from/for social signals. Another set of normalization modules can be configured to extract/derive/infer Time, Location and Context dimensions from/for Web signals. A further set of normalization modules can be configured to extract/derive/infer Time, Location and Context dimensions from/for streaming signals.

Normalization modules for extracting/deriving/inferring Time, Location, and Context dimensions can include text processing modules, NLP modules, image processing modules, video processing modules, etc. The modules can be used to extract/derive/infer data representative of Time, Location, and Context dimensions for a signal. Time, Location, and Context dimensions for a signal can be extracted/derived/inferred from metadata and/or content of the signal (e.g., an indication of an agency and/or one or more agency codes).

For example, NLP modules can analyze metadata and content of a sound clip to identify a time, location, and keywords (e.g., fire, shooter, etc.) and/or agency codes. An acoustic listener can also interpret the meaning of sounds in a sound clip (e.g., a gunshot, vehicle collision, etc.) and convert to relevant context. Live acoustic listeners can determine the distance and direction of a sound. Similarly, image processing modules can analyze metadata and pixels in an image to identify a time, location and keywords (e.g., fire, shooter, etc.) and/or agency codes. Image processing modules can also interpret the meaning of parts of an image (e.g., a person holding a gun, flames, a store logo, etc.) and convert to relevant context. Other modules can perform similar operations for other types of content including text and video.

Per signal type, each set of normalization modules can differ but may include at least some similar modules or may share some common modules. For example, similar (or the same) image analysis modules can be used to extract named entities from social signal images and public camera feeds. Likewise, similar (or the same) NLP modules can be used to extract named entities from social signal text and web text.

In some aspects, an ingested signal includes sufficient expressly defined time, location, and context information upon ingestion. The expressly defined time, location, and context information is used to determine Time, Location, and Context dimensions for the ingested signal. In other aspects, an ingested signal lacks expressly defined location information or expressly defined location information is insufficient (e.g., lacks precision) upon ingestion. In these other aspects, Location dimension or additional Location dimension can be inferred from features of an ingested signal and/or through references to other data sources. In further aspects, an ingested signal lacks expressly defined context information or expressly defined context information is insufficient (e.g., lacks precision) upon ingestion. In these further aspects, Context dimension or additional Context dimension can be inferred from features of an ingested signal and/or through reference to other data sources.

In further aspects, time information may not be included, or included time information may not be given with high enough precision and Time dimension is inferred. For example, a user may post an image to a social network which had been taken some indeterminate time earlier.

Normalization modules can use named entity recognition and reference to a geo cell database to infer Location dimension and identify a code language associated with the language. Named entities can be recognized in text, images, video, audio, or sensor data. The recognized named entities can be compared to named entities in geo cell entries. Matches indicate possible signal origination in a geographic area defined by a geo cell and an agency code language associated with that geographic area.

As such, a normalized signal can include a Time dimension, a Location dimension, a Context dimension (e.g., single source probabilities, probability details, one or more agency codes, an indication of an agency code language, etc.), a signal type, a signal source (e.g., including information indicative of an agency), and content (e.g., an indication of an agency or one or more agency codes). In one aspect, an agency is identified from one or more, and possibly multiple and overlapping, characteristics of a raw signal, such as, for example, network domain, network address, metadata, radio frequency, radio channel, agency identifier, message header, packet information, etc. Identifying an agency can include referring to external data (e.g., lists, tables, etc.) that maps raw signal characteristics to agencies.

A single source probability can be calculated by single source classifiers (e.g., machine learning models, artificial intelligence, neural networks, statistical models, etc.) that consider hundreds, thousands, or even more signal features of a signal. Single source classifiers can be based on binary models and/or multi-class models.

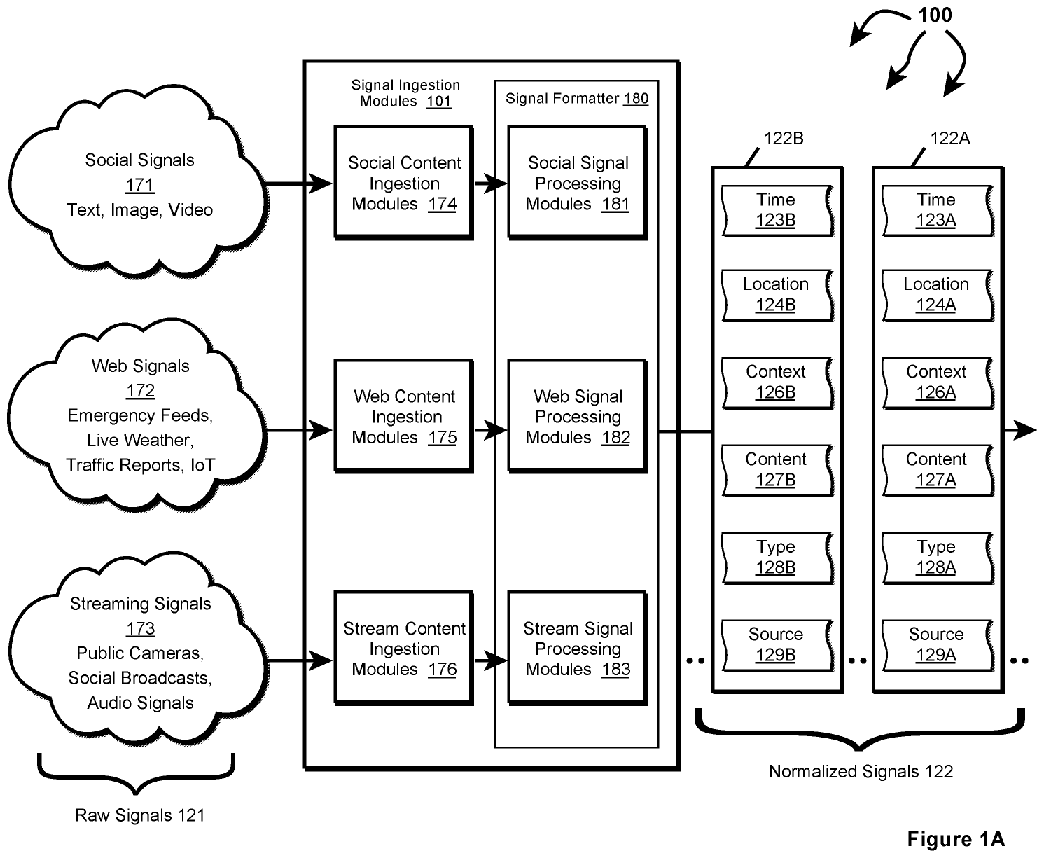

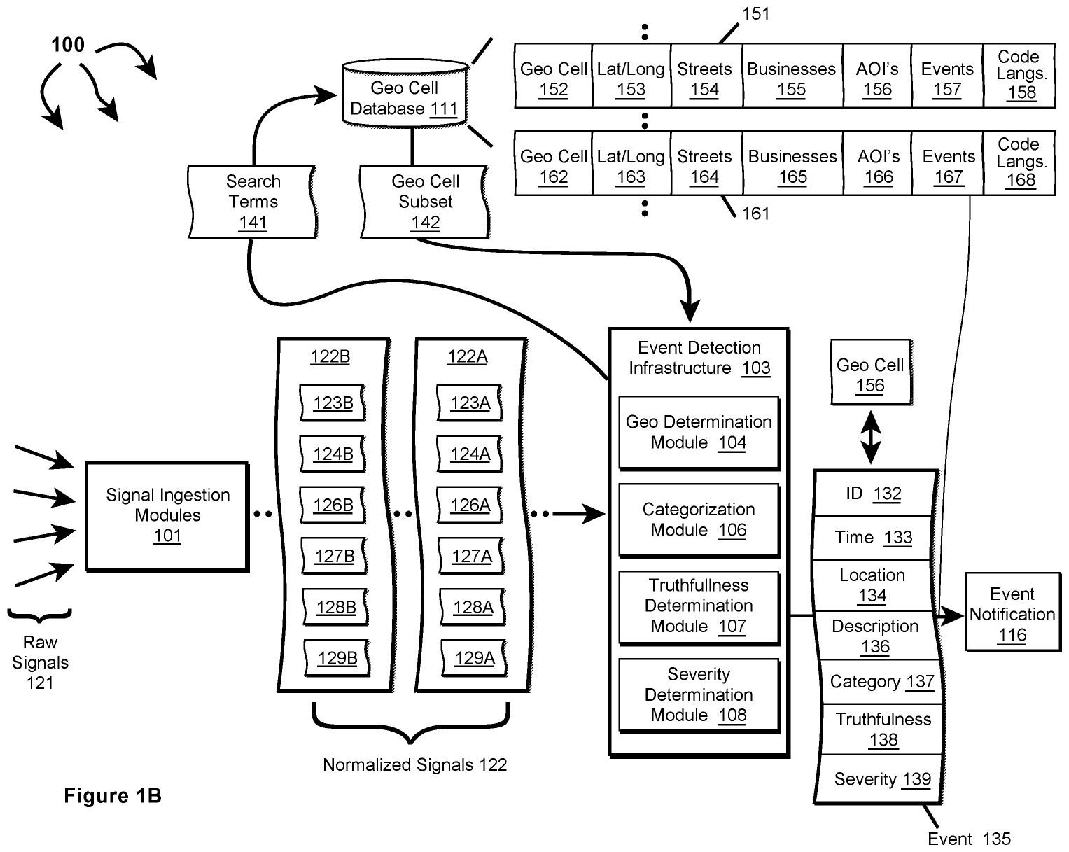

FIG. 1A depicts part of computer architecture 100 that facilitates ingesting and normalizing signals. As depicted, computer architecture 100 includes signal ingestion modules 101, social signals 171, Web signals 172, and streaming signals 173. Signal ingestion modules 101, social signals 171, Web signals 172, and streaming signals 173 can be connected to (or be part of) a network, such as, for example, a system bus, a Local Area Network (“LAN”), a Wide Area Network (“WAN”), and even the Internet. Accordingly, signal ingestion modules 101, social signals 171, Web signals 172, and streaming signals 173 as well as any other connected computer systems and their components can create and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

Signal ingestion module(s) 101 can ingest raw signals 121, including social signals 171, web signals 172, and streaming signals 173 (e.g., social posts, traffic camera feeds, other camera feeds, listening device feeds, 911 calls, weather data, planned events, IoT device data, crowd sourced traffic and road information, satellite data, air quality sensor data, smart city sensor data, public radio communication, etc.) ongoing basis and in essentially real-time. Raw signals be originate from any of a variety of sources, including but not limited to agencies, and/or may or may not contain agency codes. For example, 911 calls, Public Safety Answering Point (PSAP) communication, dispatcher radio communication, first responder radio communication, pilot communication, air traffic controller communication, etc., as well as transcripts thereof, can be from an agency and may include one or more agency codes. Agency codes can be included in different media types, such as, for example, images, spoken language (e.g., audio), or written language (e.g., text). Written language can include transcriptions of spoken language. Other raw signals can originate from other sources and/or do not include agency codes.

Signal ingestion module(s) 101 include social content ingestion modules 174, web content ingestion modules 176, stream content ingestion modules 177, and signal formatter 180. Signal formatter 180 further includes social signal processing module 181, web signal processing module 182, and stream signal processing modules 183.

For each type of signal, a corresponding ingestion module and signal processing module can interoperate to normalize the signal into a Time, Location, Context (TLC) dimensions. For example, social content ingestion modules 174 and social signal processing module 181 can interoperate to normalize social signals 171 into TLC dimensions. Similarly, web content ingestion modules 176 and web signal processing module 182 can interoperate to normalize web signals 172 into TLC dimensions. Likewise, stream content ingestion modules 177 and stream signal processing modules 183 can interoperate to normalize streaming signals 173 into TLC dimensions.

In one aspect, signal content exceeding specified size requirements (e.g., audio or video) is cached upon ingestion. Signal ingestion modules 101 include a URL or other identifier to the cached content within the context for the signal.

In one aspect, signal formatter 180 includes modules for determining a single source probability as a ratio of signals turning into events based on the following signal properties: (1) event class (e.g., fire, accident, weather, etc.), (2) media type (e.g., text (including audio transcriptions), image, audio, etc.), (3) source (e.g., twitter, traffic camera, first responder and/or dispatcher radio communication, agency, etc.), and (4) geo type (e.g., geo cell, region, or non-geo). Probabilities can be stored in a lookup table for different combinations of the signal properties. Features of a signal can be derived and used to query the lookup table. For example, the lookup table can be queried with terms (“accident”, “image”, “twitter”, “region”, an agency name, etc.). The corresponding ratio (probability) can be returned from the table.

In another aspect, signal formatter 180 includes a plurality of single source classifiers (e.g., artificial intelligence, machine learning modules, neural networks, etc.). Each single source classifier can consider hundreds, thousands, or even more signal features of a signal. Signal features of a signal can be derived and submitted to a signal source classifier. The single source classifier can return a probability that a signal indicates a type of event. Single source classifiers can be binary classifiers or multi-source classifiers.

Raw classifier output can be adjusted to more accurately represent a probability that a signal is a “true positive”. For example, 1,000 signals whose raw classifier output is 0.9 may include 80% as true positives. Thus, probability can be adjusted to 0.8 to reflect true probability of the signal being a true positive. “Calibration” can be done in such a way that for any “calibrated score” this score reflects the true probability of a true positive outcome.

Signal ingestion modules 101 can insert one or more single source probabilities and corresponding probability details into a normalized signal to represent a Context (C) dimension. Probability details can indicate a probabilistic model and features used to calculate the probability. In one aspect, a probabilistic model and signal features are contained in a hash field.

Signal ingestion modules 101 can access “transdimensionality” transformations structured and defined in a “TLC” dimensional model. Signal ingestion modules 101 can apply the “transdimensionality” transformations to generic source data in raw signals to re-encode the source data into normalized data having lower dimensionality. Dimensionality reduction can include reducing dimensionality of a raw signal to a normalized signal including a T vector, an L vector, and a C vector. At lower dimensionality, the complexity of measuring “distances” between dimensional vectors across different normalized signals is reduced.

Thus, in general, any ingested raw signals can be normalized into normalized signals including a Time (T) dimension, a Location (L) dimension, a Context (C) dimension, signal source, signal type, and content. Signal ingestion modules 101 can send normalized signals 122 to event detection infrastructure 103. In one aspect, a context includes and/or indicates one or more agency codes.

For example, signal ingestion modules 101 can send normalized signal 122A, including time 123A, location 124A, context 126A, content 127A, type 128A, and source 129A to event detection infrastructure 103. Source 129A can indicate an agency and context 126A and/or content 127A may include and/or indicate one or more agency codes. Similarly, signal ingestion modules 101 can send normalized signal 122B, including time 123B, location 124B, context 126B, content 127B, type 128B, and source 129B to event detection infrastructure 103. Source 129B can indicate an agency and context 126B and/or content 127B may include and/or indicate one or more agency codes.

In one aspect, a raw signal source is not an agency and/or a raw signal does not include an agency code. During normalization and/or based on location, one or more relevant agencies and/or one or more relevant agency codes can be determined. For example, signal ingestion modules 101 may ingest a video of a person with a weapon. Signal ingestion modules 101 can determine the location captured in the video. Based on the location, signal ingestion modules 101 can identify relevant agencies (e.g., police departments, fire department, ambulance services, etc.) associated with the location. Signal ingestion modules 101 can identify one or more code languages corresponding to the relevant agencies. Signal ingestion modules 101 can insert one or more agency codes (e.g., associated with and/or corresponding to “person with a weapon”) from the one or more relevant code languages into the raw signal and/or into a corresponding normalized signal. As such, an event detected from the corresponding normalized signal can be annotated with and/or can include the one or more agency codes. Accordingly, if a relevant agency is notified of the event, the agency may able to more efficiently and effectively handle the event based on the meaning of the one or more agency codes.

Event Detection

FIG. 1B depicts part of computer architecture 100 that facilitates detecting events. As depicted, computer architecture 100 includes geo cell database 111 and event notification 116. Geo cell database 111 and event notification 116 can be connected to (or be part of) a network with signal ingestion modules 101 and event detection infrastructure 103. As such, geo cell database 111 and event notification 116 can create and exchange message related data over the network.

As described, in general, on an ongoing basis, concurrently with signal ingestion (and also essentially in real-time), event detection infrastructure 103 detects different categories of (planned and/or unplanned) events (e.g., fire, police response, mass shooting, traffic accident, natural disaster, storm, active shooter, concerts, protests, etc.) in different locations (e.g., anywhere across a geographic area, such as, Europe, the United States, a State, a defined area, an impacted area, an area defined by a geo cell, an address, etc.), at different times from Time, Location, and Context dimensions included in normalized signals. Since, normalized signals are normalized to include Time, Location, and Context dimensions, event detection infrastructure 103 can handle normalized signals in a more uniform manner increasing event detection efficiency and effectiveness.

Event detection infrastructure 103 can also determine an event truthfulness, event severity, an associated geo cell, a corresponding code language, etc. In one aspect, a Context dimension in a normalized signal increases the efficiency and effectiveness of determining truthfulness, severity, and an associated geo cell.

Generally, an event truthfulness indicates how likely a detected event is actually an event (vs. a hoax, fake, misinterpreted, etc.). Truthfulness can range from less likely to be true to more likely to be true. In one aspect, truthfulness is represented as a numerical value, such as, for example, from 1 (less truthful) to 10 (more truthful) or as percentage value in a percentage range, such as, for example, from 0% (less truthful) to 100% (more truthful). Other truthfulness representations are also possible. For example, truthfulness can be a dimension or represented by one or more vectors.

Generally, an event severity indicates how severe an event is (e.g., what degree of badness, what degree of damage, etc. is associated with the event). Severity can range from less severe (e.g., a single vehicle accident without injuries) to more severe (e.g., multi vehicle accident with multiple injuries and a possible fatality). As another example, a shooting event can also range from less severe (e.g., one victim without life threatening injuries) to more severe (e.g., multiple injuries and multiple fatalities). In one aspect, severity is represented as a numerical value, such as, for example, from 1 (less severe) to 5 (more severe). Other severity representations are also possible. For example, severity can be a dimension or represented by one or more vectors.

An agency code can specify degrees of severity to a relevant agency, such as, for example, one agency code indicative of a traffic accident relative to another agency code indicative of a traffic accident with injuries or a fatality. As such, an agency code may be considered in severity computations.

In general, event detection infrastructure 103 can include a geo determination module including modules for processing different kinds of content including location, time, context, text (including audio transcriptions containing agency codes), images, audio (including agency codes), and video into search terms. The geo determination module can query a geo cell database with search terms formulated from normalized signal content. The geo cell database can return any geo cells having matching supplemental information. For example, if a search term includes a street name, a subset of one or more geo cells including the street name in supplemental information can be returned to the event detection infrastructure.

Event detection infrastructure 103 can use the subset of geo cells to determine a geo cell associated with an event location. Events associated with a geo cell can be stored back into an entry for the geo cell in the geo cell database. Thus, over time an historical progression of events within a geo cell can be accumulated. Event detection infrastructure 103 can also identify code languages associated with a geo cell.

As such, event detection infrastructure 103 can assign an event ID, an event time, an event location, an event category (e.g., including and/or indicating an agency code), an event description (e.g., including and/or indicating a code language and one or more agency codes), an event truthfulness, and an event severity to each detected event. Detected events can be sent to relevant entities (e.g., agencies), including to mobile devices, to computer systems, to APIs, to data storage, etc.

Event detection infrastructure 103 detects events from information (e.g., agency codes) contained in normalized signals 122. Event detection infrastructure 103 can detect an event from a single normalized signal 122 or from multiple normalized signals 122. In one aspect, event detection infrastructure 103 detects an event based on information contained in one or more normalized signals 122. In another aspect, event detection infrastructure 103 detects a possible event based on information contained in one or more normalized signals 122. Event detection infrastructure 103 then validates the potential event as an event based on information contained in one or more other normalized signals 122.

As depicted, event detection infrastructure 103 includes geo determination module 104, categorization module 106, truthfulness determination module 107, and severity determination module 108.

Geo determination module 104 can include NLP modules, image analysis modules, etc. for identifying location information from a normalized signal. Geo determination module 104 can formulate (e.g., location) search terms 141 by using NLP modules to process audio, using image analysis modules to process images, etc. Search terms can include street addresses, building names, landmark names, location names, school names, image fingerprints, agency codes, etc. Event detection infrastructure 103 can use a URL or identifier to access cached content when appropriate.

Categorization module 106 can categorize a detected event into one of a plurality of different categories (e.g., fire, police response, mass shooting, traffic accident, natural disaster, storm, active shooter, concerts, protests, etc.) based on the content of normalized signals (e.g., an agency code language and/or one or more agency codes) used to detect and/or otherwise related to an event.

Truthfulness determination module 107 can determine the truthfulness of a detected event based on one or more of: source, type, age, and content of normalized signals used to detect and/or otherwise related to the event. Some signal types may be inherently more reliable than other signal types. For example, video from a live traffic camera feed may be more reliable than text in a social media post. Some signal sources may be inherently more reliable than others. For example, a social media account of a government agency may be more reliable than a social media account of an individual. The reliability of a signal can decay over time.

Severity determination module 108 can determine the severity of a detected event based on or more of: location, content (e.g., an agency code language, agency codes, keywords, etc.), and volume of normalized signals used to detect and/or otherwise related to an event. Events at some locations may be inherently more severe than events at other locations. For example, an event at a hospital is potentially more severe than the same event at an abandoned warehouse. Event category can also be considered when determining severity. For example, an event categorized as a “Shooting” may be inherently more severe than an event categorized as “Police Presence” since a shooting implies that someone has been injured.

Geo cell database 111 includes a plurality of geo cell entries. Each geo cell entry is included in a geo cell defining an area and corresponding supplemental information about things included in the defined area. The corresponding supplemental information can include latitude/longitude, street names in the area defined by and/or beyond the geo cell, businesses in the area defined by the geo cell, other Areas of Interest (AOIs) (e.g., event venues, such as, arenas, stadiums, theaters, concert halls, etc.) in the area defined by the geo cell, image fingerprints derived from images captured in the area defined by the geo cell, prior events that have occurred in the area defined by the geo cell, one or more agency code languages used in the defined area. For example, geo cell entry 151 includes geo cell 152, lat/lon 153, streets 154, businesses 155, AO501Is 156, prior events 157, and code languages 158. Each event in prior events 157 can include a location (e.g., a street address), a time (event occurrence time), an event category (e.g., including and/or indicating an agency code language and one or more agency codes), an event truthfulness, an event severity, and an event description (e.g., including and/or indicating an agency code language and one or more agency codes). Similarly, geo cell entry 161 includes geo cell 162, lat/lon 163, streets 164, businesses 165, AOIs 166, prior events 167, code languages 168. Each event in prior events 167 can include a location (e.g., a street address), a time (event occurrence time), an event category (e.g., including and/or indicating one or more agency codes), an event truthfulness, an event severity, and an event description (e.g., including and/or indicating one or more agency codes).

Other geo cell entries can include the same or different (more or less) supplemental information, for example, depending on infrastructure density in an area. For example, a geo cell entry for an urban area can contain more diverse supplemental information than a geo cell entry for an agricultural area (e.g., in an empty field).

Geo cell database 111 can store geo cell entries in a hierarchical arrangement based on geo cell precision. As such, geo cell information of more precise geo cells is included in the geo cell information for any less precise geo cells that include the more precise geo cell.

Geo determination module 104 can query geo cell database 111 with search terms 141. Geo cell database 111 can identify any geo cells having supplemental information that matches search terms 141. For example, if search terms 141 include a street address and a business name, geo cell database 111 can identify geo cells having the street name and business name in the area defined by the geo cell. Geo cell database 111 can return any identified geo cells (and corresponding code languages) to geo determination module 104 in geo cell subset 142.

Geo determination module 104 can use geo cell subset 142 to determine the location of event 135 and/or a geo cell associated with event 135. As depicted, event 135 includes event ID 132, time 133, location 137, description 136 (possibly including an indication of an agency code language and one or more agency codes), category 137 (possibly including an indication of an agency code language and one or more agency codes), truthfulness 138, and severity 139.

Event detection infrastructure 103 can also determine that event 135 occurred in an area defined by geo cell 162 (e.g., a geohash having precision of level 7 or level 9). For example, event detection infrastructure 103 can determine that location 134 is in the area defined by geo cell 162. As such, event detection infrastructure 103 can store event 135 in events 167 (i.e., historical events that have occurred in the area defined by geo cell 162).

Event detection infrastructure 103 can also send event 135 to event notification module 116. Event notification module 116 can notify one or more entities (e.g., relevant agencies) about event 135.

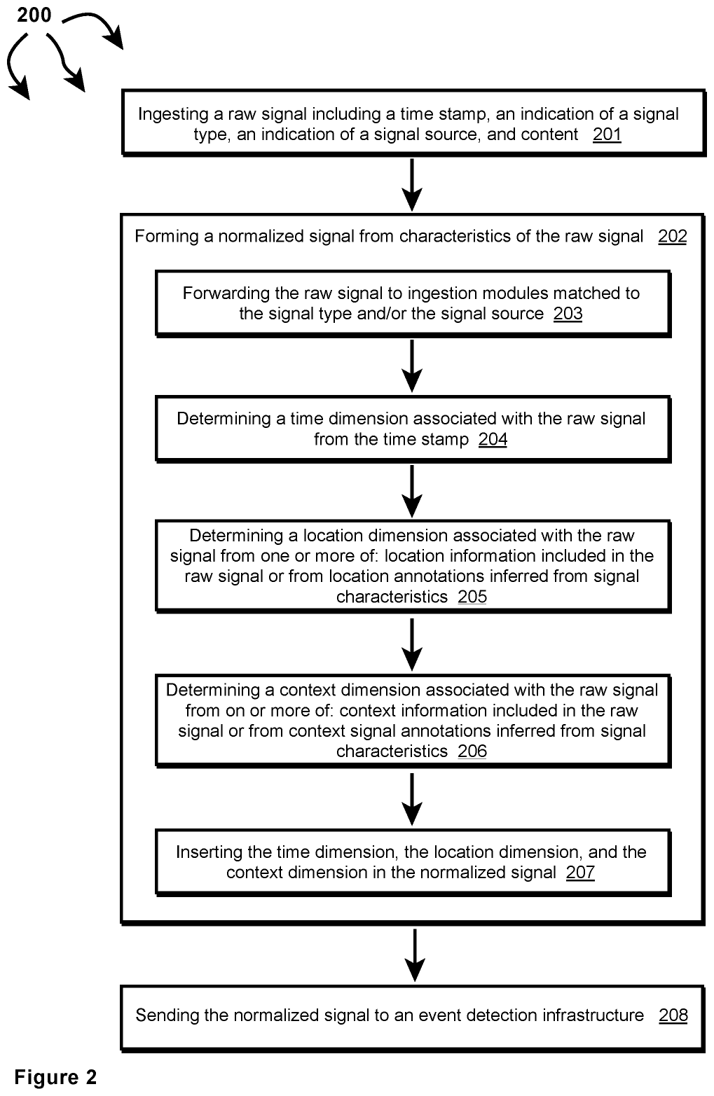

FIG. 2 illustrates a flow chart of an example method 200 for normalizing ingested signals. Method 200 will be described with respect to the components and data in computer architecture 100.

Method 200 includes ingesting a raw signal including a time stamp, an indication of a signal type, an indication of a signal source, and content (201). For example, signal ingestion modules 101 can ingest a raw signal 121 from one of: social signals 171, web signals 172, or streaming signals 173.

Method 200 includes forming a normalized signal from characteristics of the raw signal (202). For example, signal ingestion modules 101 can form a normalized signal 122A from the ingested raw signal 121.

Forming a normalized signal includes forwarding the raw signal to ingestion modules matched to the signal type and/or the signal source (203). For example, if ingested raw signal 121 is from social signals 171, raw signal 121 can be forwarded to social content ingestion modules 174 and social signal processing modules 181. If ingested raw signal 121 is from web signals 172, raw signal 121 can be forwarded to web content ingestion modules 175 and web signal processing modules 182. If ingested raw signal 121 is from streaming signals 173, raw signal 121 can be forwarded to streaming content ingestion modules 176 and streaming signal processing modules 183.

Forming a normalized signal includes determining a time dimension associated with the raw signal from the time stamp (204). For example, signal ingestion modules 101 can determine time 123A from a time stamp in ingested raw signal 121.

Forming a normalized signal includes determining a location dimension associated with the raw signal from one or more of: location information included in the raw signal or from location annotations inferred from signal characteristics (205). For example, signal ingestion modules 101 can determine location 124A from location information included in raw signal 121 or from location annotations derived from characteristics of raw signal 121 (e.g., signal source, signal type, signal content).

Forming a normalized signal includes determining a context dimension associated with the raw signal from one or more of: context information included in the raw signal or from context signal annotations inferred from signal characteristics (206). For example, signal ingestion modules 101 can determine context 126A from context information included in raw signal 121 or from context annotations derived from characteristics of raw signal 121 (e.g., signal source, signal type, signal content). Context information and/or context annotations can include agency codes.

Forming a normalized signal includes inserting the time dimension, the location dimension, and the context dimension in the normalized signal (207). For example, signal ingestion modules 101 can insert time 123A, location 124A, and context 126A in normalized signal 122. Method 200 includes sending the normalized signal to an event detection infrastructure (208). For example, signal ingestion modules 101 can send normalized signal 122A to event detection infrastructure 103.

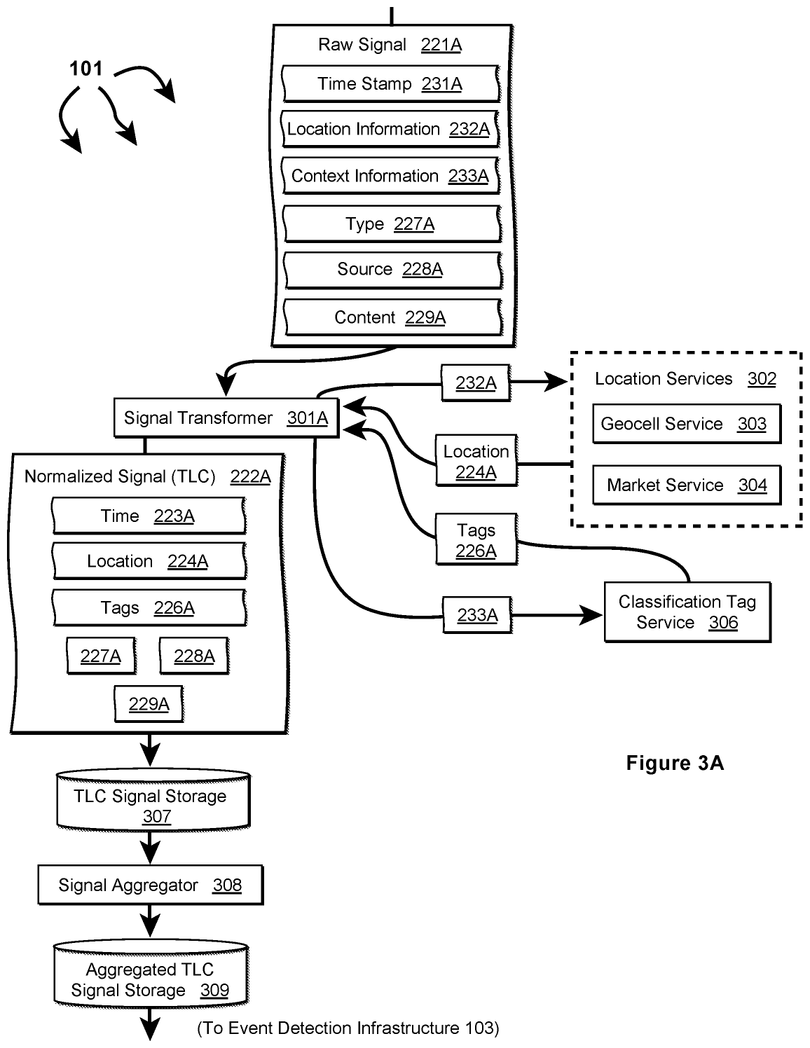

FIGS. 3A, 3B, and 3C depict other example components that can be included in signal ingestion modules 101. Signal ingestion modules 101 can include signal transformers for different types of signals including signal transformer 301A (for TLC signals), signal transformer 301B (for TL signals), and signal transformer 301C (for T signals). In one aspect, a single module combines the functionality of multiple different signal transformers.

Signal ingestion modules 101 can also include location services 302, classification tag service 306, signal aggregator 308, context inference module 312, and location inference module 316. Location services 302, classification tag service 306, signal aggregator 308, context inference module 312, and location inference module 316 or parts thereof can interoperate with and/or be integrated into any of ingestion modules 174, web content ingestion modules 176, stream content ingestion modules 177, social signal processing module 181, web signal processing module 182, and stream signal processing modules 183. Location services 302, classification tag service 306, signal aggregator 308, context inference module 312, and location inference module 316 can interoperate to implement “transdimensionality” transformations to reduce raw signal dimensionality.

Signal ingestion modules 101 can also include storage for signals in different stages of normalization, including TLC signal storage 307, TL signal storage 311, T signal storage 313, TC signal storage 314, and aggregated TLC signal storage 309. In one aspect, data ingestion modules 101 implement a distributed messaging system. Each of signal storage 307, 309, 311, 313, and 314 can be implemented as a message container (e.g., a topic) associated with a type of message.

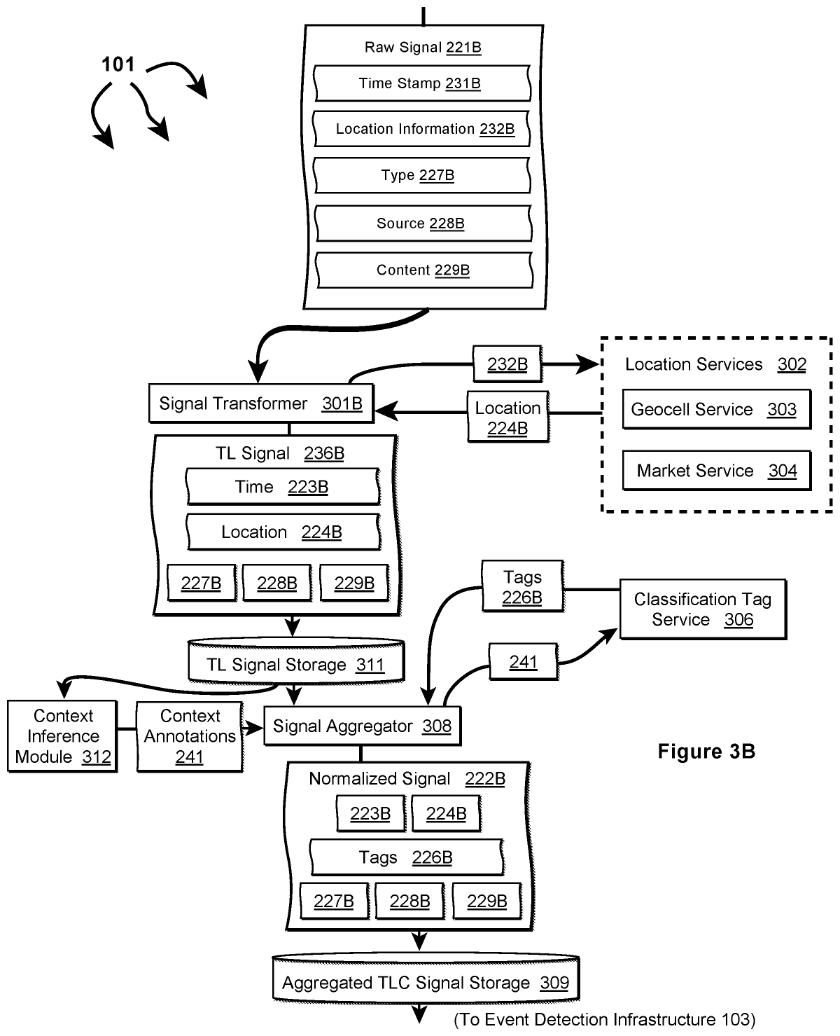

FIG. 4 illustrates a flow chart of an example method 400 for normalizing an ingested signal including time information, location information, and context information. Method 400 will be described with respect to the components and data in FIG. 3A.

Method 400 includes accessing a raw signal including a time stamp, location information, context information, an indication of a signal type, an indication of a signal source, and content (401). For example, signal transformer 301A can access raw signal 221A. Raw signal 221A includes timestamp 231A, location information 232A (e.g., lat/lon, GPS coordinates, etc.), context information 233A (e.g., text expressly indicating a type of event, an agency code, etc.), signal type 227A (e.g., social media, 911 communication, traffic camera feed, radio communication transcript, etc.), signal source 228A (e.g., Facebook, twitter, Waze, agency, Public Safety Access Point (PSAP), agency radio system, etc.), and signal content 229A (e.g., one or more of: audio, image, video, text, keyword, locale, etc.). Context information 233A and/or content 229A may indicate and/or may include an agency and/or one or more agency codes.

Method 400 includes determining a Time dimension for the raw signal (402). For example, signal transformer 301A can determine time 223A from timestamp 231A.

Method 400 includes determining a Location dimension for the raw signal (403). For example, signal transformer 301A sends location information 232A to location services 302. Geo cell service 303 can identify a geo cell corresponding to location information 232A. Market service 304 can identify a designated market area (DMA) (or jurisdiction and/or agency) corresponding to location information 232A. Location services 302 can include the identified geo cell and/or DMA (or jurisdiction and/or agency) in location 224A. Location services 302 return location 224A to signal transformer 301.

Method 400 includes determining a Context dimension for the raw signal (404). For example, signal transformer 301A sends context information 233A (e.g., an agency code language and agency code) to classification tag service 306. Classification tag service 306 identifies one or more classification tags 226A (e.g., fire, police presence, accident, natural disaster, etc.) from context information 233A. Classification tag service 306 returns classification tags 226A to signal transformer 301A.

Method 400 includes inserting the Time dimension, the Location dimension, and the Context dimension in a normalized signal (405). For example, signal transformer 301A can insert time 223A, location 224A, and tags 226A in normalized signal 222A (a TLC signal). Method 400 includes storing the normalized signal in signal storage (406). For example, signal transformer 301A can store normalized signal 222A in TLC signal storage 307. (Although not depicted, timestamp 231A, location information 232A, and context information 233A [including any agency code language and/or one or more agency codes] can also be included (or remain) in normalized signal 222A).

Method 400 includes storing the normalized signal in aggregated storage (406). For example, signal aggregator 308 can aggregate normalized signal 222A along with other normalized signals determined to relate to the same event. In one aspect, signal aggregator 308 forms a sequence of signals related to the same event. Signal aggregator 308 stores the signal sequence, including normalized signal 222A, in aggregated TLC storage 309 and eventually forwards the signal sequence to event detection infrastructure 103.

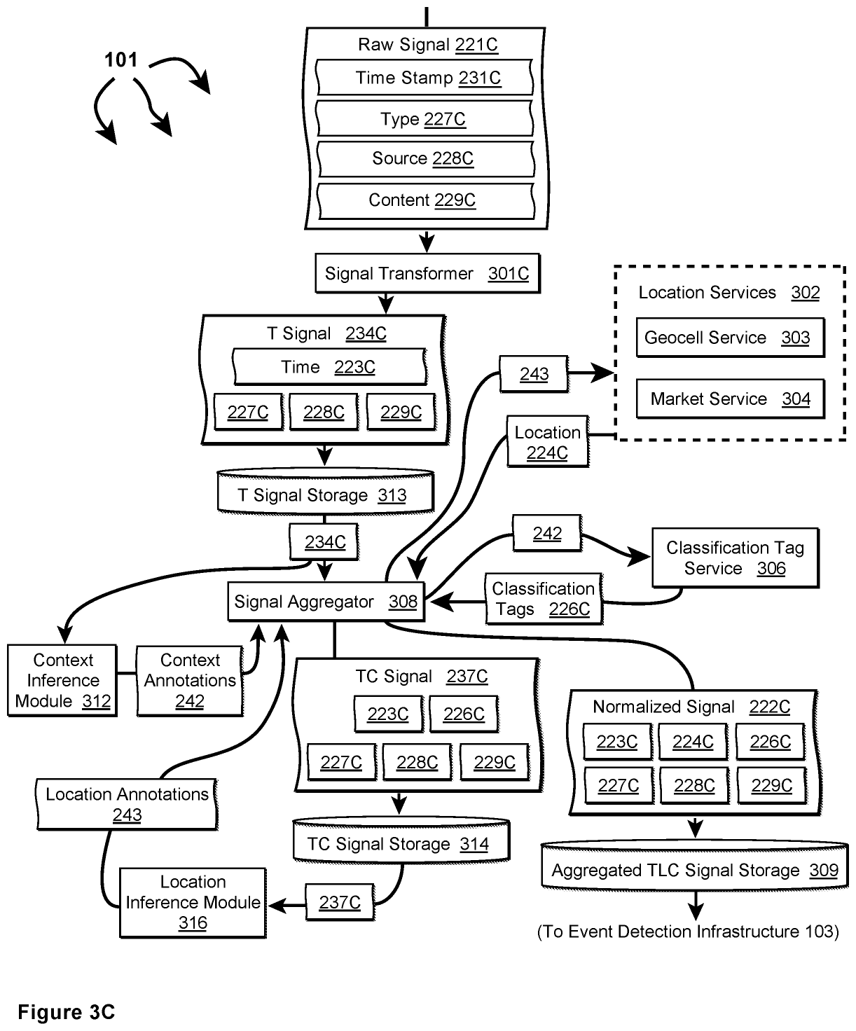

FIG. 5 illustrates a flow chart of an example method 500 for normalizing an ingested signal including time information and location information. Method 500 will be described with respect to the components and data in FIG. 3B.

Method 500 includes accessing a raw signal including a time stamp, location information, an indication of a signal type, an indication of a signal source, and content (501). For example, signal transformer 301B can access raw signal 221B. Raw signal 221B includes timestamp 231B, location information 232B (e.g., lat/lon, GPS coordinates, etc.), signal type 227B (e.g., social media, 911 communication, traffic camera feed, radio communication transcript, etc.), signal source 228B (e.g., Facebook, twitter, Waze, agency, PSAP, agency radio system, etc.), and signal content 229B (e.g., one or more of: audio, image, video, audio, text, keyword, locale, etc.). Content 229B may indicate and/or may include an agency and/or one or more agency codes.

Method 500 includes determining a Time dimension for the raw signal (502). For example, signal transformer 301B can determine time 223B from timestamp 231B.

Method 500 includes determining a Location dimension for the raw signal (503). For example, signal transformer 301B sends location information 232B to location services 302. Geo cell service 303 can be identify a geo cell corresponding to location information 232B. Market service 304 can identify a designated market area (DMA) (or jurisdiction or agency) corresponding to location information 232B. Location services 302 can include the identified geo cell and/or DMA (or jurisdiction or agency) in location 224B. Location services 302 returns location 224B to signal transformer 301.

Method 500 includes inserting the Time dimension and Location dimension into a signal (504). For example, signal transformer 301B can insert time 223B and location 224B into TL signal 236B. (Although not depicted, timestamp 231B and location information 232B can also be included (or remain) in TL signal 236B). Method 500 includes storing the signal, along with the determined Time dimension and Location dimension, to a Time, Location message container (505). For example, signal transformer 301B can store TL signal 236B to TL signal storage 311. Method 500 includes accessing the signal from the Time, Location message container (506). For example, signal aggregator 308 can access TL signal 236B from TL signal storage 311.

Method 500 includes inferring context annotations based on characteristics of the signal (507). For example, context inference module 312 can access TL signal 236B from TL signal storage 311. Context inference module 312 can infer context annotations 241 (e.g., an agency, one or more agency codes, etc.) from characteristics of TL signal 236B, including inferring context annotations from one or more of: time 223B, location 224B, type 227B, source 228B, and content 229B. In one aspect, context inference module 212 includes one or more of: NLP modules, audio analysis modules, image analysis modules, video analysis modules, etc. Context inference module 212 can process content 229B in view of time 223B, location 224B, type 227B, source 228B, to infer context annotations 241 (e.g., using machine learning, artificial intelligence, neural networks, machine classifiers, etc.). For example, if content 229B is an image that depicts flames and a fire engine, context inference module 212 can infer that content 229B is related to a fire. Context inference 212 module can return context annotations 241 to signal aggregator 208.

Method 500 includes appending the context annotations to the signal (508). For example, signal aggregator 308 can append context annotations 241 to TL signal 236B. Method 500 includes looking up classification tags corresponding to the classification annotations (509). For example, signal aggregator 308 can send context annotations 241 to classification tag service 306. Classification tag service 306 can identify one or more classification tags 226B (a Context dimension) (e.g., fire, police presence, accident, natural disaster, etc.) from context annotations 241. Classification tag service 306 returns classification tags 226B to signal aggregator 308. In one aspect, classification tags 226B include and/or are associated with an agency code language and/or one or more agency codes.

Method 500 includes inserting the classification tags in a normalized signal (510). For example, signal aggregator 308 can insert tags 226B (a Context dimension) into normalized signal 222B (a TLC signal). Method 500 includes storing the normalized signal in aggregated storage (511). For example, signal aggregator 308 can aggregate normalized signal 222B along with other normalized signals determined to relate to the same event. In one aspect, signal aggregator 308 forms a sequence of signals related to the same event. Signal aggregator 308 stores the signal sequence, including normalized signal 222B, in aggregated TLC storage 309 and eventually forwards the signal sequence to event detection infrastructure 103. (Although not depicted, timestamp 231B, location information 232B, and context annotations 241 [including any agency code language and/or one or more agency codes] can also be included (or remain) in normalized signal 222B).

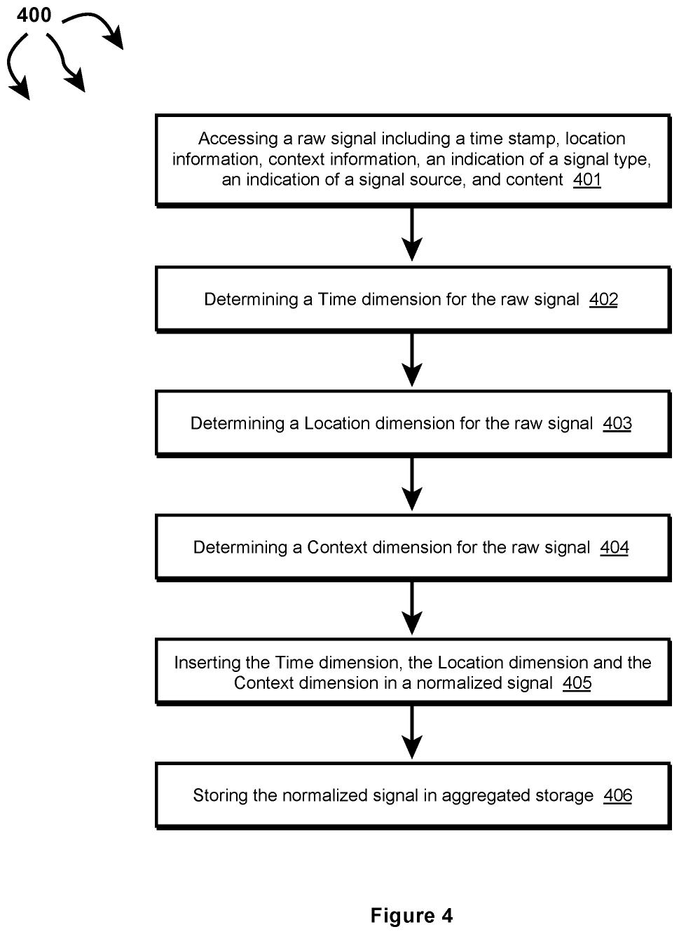

FIG. 6 illustrates a flow chart of an example method 600 for normalizing an ingested signal including time information and location information. Method 600 will be described with respect to the components and data in FIG. 3C.

Method 600 includes accessing a raw signal including a time stamp, an indication of a signal type, an indication of a signal source, and content (601). For example, signal transformer 301C can access raw signal 221C. Raw signal 221C includes timestamp 231C, signal type 227C (e.g., social media, 911 communication, traffic camera feed, etc.), signal source 228C (e.g., Facebook, twitter, Waze, agency, PSAP, agency radio system, etc.), and signal content 229C (e.g., one or more of: audio, image, video, text, keyword, locale, etc.). Content 229C may indicate and/or may include an agency and/or one or more agency codes.

Method 600 includes determining a Time dimension for the raw signal (602). For example, signal transformer 301C can determine time 223C from timestamp 231C. Method 600 includes inserting the Time dimension into a T signal (603). For example, signal transformer 301C can insert time 223C into T signal 234C. (Although not depicted, timestamp 231C can also be included (or remain) in T signal 234C).

Method 600 includes storing the T signal, along with the determined Time dimension, to a Time message container (604). For example, signal transformer 301C can store T signal 236C to T signal storage 313. Method 600 includes accessing the T signal from the Time message container (605). For example, signal aggregator 308 can access T signal 234C from T signal storage 313.

Method 600 includes inferring context annotations based on characteristics of the T signal (606). For example, context inference module 312 can access T signal 234C from T signal storage 313. Context inference module 312 can infer context annotations 242 (e.g., an agency, one or more agency codes, etc.) from characteristics of T signal 234C, including inferring context annotations from one or more of: time 223C, type 227C, source 228C, and content 229C. As described, context inference module 212 can include one or more of: NLP modules, audio analysis modules, image analysis modules, video analysis modules, etc. Context inference module 212 can process content 229C in view of time 223C, type 227C, source 228C, to infer context annotations 242 (e.g., using machine learning, artificial intelligence, neural networks, machine classifiers, etc.). For example, if content 229C is a video depicting two vehicles colliding on a roadway, context inference module 212 can infer that content 229C is related to an accident. Context inference 212 module can return context annotations 242 to signal aggregator 208.

Method 600 includes appending the context annotations to the T signal (607). For example, signal aggregator 308 can append context annotations 242 to T signal 234C. Method 600 includes looking up classification tags corresponding to the classification annotations (608). For example, signal aggregator 308 can send context annotations 242 to classification tag service 306. Classification tag service 306 can identify one or more classification tags 226C (a Context dimension) (e.g., fire, police presence, accident, natural disaster, etc.) from context annotations 242. Classification tag service 306 returns classification tags 226C to signal aggregator 208. In one aspect, classification tags 226C include and/or are associated with an agency code language and/or one or more agency codes.

Method 600 includes inserting the classification tags into a TC signal (609). For example, signal aggregator 308 can insert tags 226C into TC signal 237C. Method 600 includes storing the TC signal to a Time, Context message container (610). For example, signal aggregator 308 can store TC signal 237C in TC signal storage 314. (Although not depicted, timestamp 231C and context annotations 242 [including any agency code language and/or one or more agency codes] can also be included (or remain) in TC signal 237C).

Method 600 includes inferring location annotations based on characteristics of the TC signal (611). For example, location inference module 316 can access TC signal 237C from TC signal storage 314. Location inference module 316 can include one or more of: NLP modules, audio analysis modules, image analysis modules, video analysis modules, etc. Location inference module 316 can process content 229C in view of time 223C, type 227C, source 228C, and classification tags 226C (and possibly context annotations 242) to infer location annotations 243 (e.g., using machine learning, artificial intelligence, neural networks, machine classifiers, etc.). For example, if content 229C is a video depicting two vehicles colliding on a roadway, the video can include a nearby street sign, business name, etc. Location inference module 316 can infer a location from the street sign, business name, etc. Location inference module 316 can return location annotations 243 to signal aggregator 308.

Method 600 includes appending the location annotations to the TC signal with location annotations (612). For example, signal aggregator 308 can append location annotations 243 to TC signal 237C. Method 600 determining a Location dimension for the TC signal (613). For example, signal aggregator 308 can send location annotations 243 to location services 302. Geo cell service 303 can identify a geo cell corresponding to location annotations 243. Market service 304 can identify a designated market area (DMA) (or jurisdiction and/or agency) corresponding to location annotations 243. Location services 302 can include the identified geo cell and/or DMA (or jurisdiction or agency) in location 224C. Location services 302 returns location 224C to signal aggregation services 308.

Method 600 includes inserting the Location dimension into a normalized signal (614). For example, signal aggregator 308 can insert location 224C into normalized signal 222C. Method 600 includes storing the normalized signal in aggregated storage (615). For example, signal aggregator 308 can aggregate normalized signal 222C along with other normalized signals determined to relate to the same event. In one aspect, signal aggregator 308 forms a sequence of signals related to the same event. Signal aggregator 308 stores the signal sequence, including normalized signal 222C, in aggregated TLC storage 309 and eventually forwards the signal sequence to event detection infrastructure 103. (Although not depicted, timestamp 231C, context annotations 242 [including any agency code language and/or one or more agency codes], and location annotations 243, can also be included (or remain) in normalized signal 222C).

In another aspect, a Location dimension is determined prior to a Context dimension when a T signal is accessed. A Location dimension (e.g., geo cell and/or DMA) (or jurisdiction or agency) and/or location annotations are used when inferring context annotations.

Accordingly, location services 302 can identify a geo cell and/or DMA (or jurisdiction or agency) associated with a signal from location information in the signal and/or from inferred location annotations. Similarly, classification tag service 306 can identify classification tags for a signal from context information in the signal and/or from inferred context annotations.

Signal aggregator 308 can concurrently handle a plurality of signals in a plurality of different stages of normalization. For example, signal aggregator 308 can concurrently ingest and/or process a plurality T signals, a plurality of TL signals, a plurality of TC signals, and a plurality of TLC signals. Accordingly, aspects of the invention facilitate acquisition of live, ongoing forms of data into an event detection system with signal aggregator 308 acting as an “air traffic controller” of live data. Signals from multiple sources of data can be aggregated and normalized for a common purpose (e.g., of event detection). Data ingestion, event detection, and event notification can process data through multiple stages of logic with concurrency.

As such, a unified interface can handle incoming signals and content of any kind. The interface can handle live extraction of signals across dimensions of time, location, and context. In some aspects, heuristic processes are used to determine one or more dimensions. Acquired signals can include text and images as well as live-feed binaries, including live media in audio, speech, fast still frames, video streams, etc.

Signal normalization enables the world's live signals to be collected at scale and analyzed for detection and validation of live events happening globally. A data ingestion and event detection pipeline aggregates signals and combines detections of various strengths into truthful events. Thus, normalization increases event detection efficiency facilitating event detection closer to “live time” or at “moment zero”.

Multi-Source Event Detection

As described, aspects of the invention can normalize raw signals into a common format that includes Time, Location, and Context (or “TLC”) format. Per signal type, signal ingestion modules identify and/or infer a time, a location, and a context associated with a signal. Different ingestion modules can be utilized/tailored to identify time, location, and context for different signal types. Time (T) can be a time of origin or “event time” of a signal. Location (L) can be anywhere across a geographic area, such as, a country (e.g., the United States), a State, a defined area, an impacted area, an area defined by a geo cell, an address, etc.

Context (C) indicates circumstances surrounding formation/origination of a raw signal in terms that facilitate understanding and assessment of the raw signal (e.g., an agency, a jurisdiction, one or more agency codes, etc.). The context of a raw signal can be derived from express as well as inferred signal features of the raw signal.

As described, signal ingestion modules can include one or more single source classifiers. A single source classifier can compute a single source probability for a raw signal from features of the raw signal. A single source probability can reflect a mathematical probability or approximation of a mathematical probability (e.g., a percentage between 0%-100%) of an event actually occurring. A single source classifier can be configured to compute a single source probability for a single event type or to compute a single source probability for each of a plurality of different event types. A single source classifier can compute a single source probability using artificial intelligence, machine learning, neural networks, logic, heuristics, etc.

As such, single source probabilities and corresponding probability details can represent Context. Probability details can indicate (e.g., can include a hash field indicating) a probability version and (express and/or inferred) signal features considered in a signal source probability calculation.

Concurrently with signal ingestion, the event detection infrastructure considers features of different combinations of normalized signals to attempt to identify events of interest to various parties. Features can be derived from an individual signal and/or from a group of signals and may indicate and/or include one or more of: an agency, an agency code language, one or more agency codes, etc.

For example, the event detection infrastructure can derive first features of a first normalized signal and can derive second features of a second normalized signal. Individual signal features can include: signal type, signal source, signal content, signal time (T), signal location (L), signal context (C), other circumstances of signal creation, etc. The event detection infrastructure can detect an event of interest to one or more parties from the first features and the second features collectively. First features and/or second features can include and/or be derived from an indication of an agency or jurisdiction, an indication of a code language, one or more agency codes, etc.

Alternately, the event detection infrastructure can derive first features of each normalized signal included in a first one or more normalized individual signals. The event detection infrastructure can detect a possible event of interest to one or more parties from the first features. The event detection infrastructure can derive second features of each normalized signal included in a second one or more individual signals. The event detection infrastructure can validate the possible event of interest as an actual event of interest to the one or more parties from the second features.

More specifically, the event detection infrastructure can use single source probabilities to detect and/or validate events. For example, the event detection infrastructure can detect an event of interest to one or more parties based on a single source probability of a first signal and a single source probability of second signal collectively. Alternately, the event detection infrastructure can detect a possible event of interest to one or more parties based on single source probabilities of a first one or more signals. The event detection infrastructure can validate the possible event as an actual event of interest to one or more parties based on single source probabilities of a second one or more signals.

The event detection infrastructure can group normalized signals having sufficient temporal similarity and/or sufficient spatial similarity (e.g., same agency, same jurisdiction, etc.) to one another in a signal sequence. Temporal similarity of normalized signals can be determined by comparing Time (T) of the normalized signals. In one aspect, temporal similarity of a normalized signal and another normalized signal is sufficient when the Time (T) of the normalized signal is within a specified time of the Time (T) of the other normalized signal. A specified time can be virtually any time value, such as, for example, ten seconds, 30 seconds, one minute, two minutes, five minutes, ten minutes, 30 minutes, one hour, two hours, four hours, etc. A specified time can vary by detection type. For example, some event types (e.g., a fire) inherently last longer than other types of events (e.g., a shooting). Specified times can be tailored per detection type.

Spatial similarity of normalized signals can be determined by comparing Location (L) of the normalized signals. In one aspect, spatial similarity of a normalized signal and another normalized signal is sufficient when the Location (L) of the normalized signal is within a specified distance of the Location (L) of the other normalized signal. A specified distance can be virtually any distance value, such as, for example, a linear distance or radius (a number of feet, meters, miles, kilometers, etc.), within a specified number of geo cells of specified precision, etc.

In one aspect, any normalized signal having sufficient temporal and spatial similarity to another normalized signal can be added to a signal sequence.

In another aspect, a single source probability for a signal is computed from features of the signal (e.g., one or more agency codes). The single source probability can reflect a mathematical probability or approximation of a mathematical probability of an event actually occurring. A normalized signal having a signal source probability above a threshold (e.g., greater than 4%) is indicated as an “elevated” signal. Elevated signals can be used to initiate and/or can be added to a signal sequence. On the other hand, non-elevated signals may not be added to a signal sequence.

In one aspect, a first threshold is considered for signal sequence initiation and a second threshold is considered for adding additional signals to an existing signal sequence. A normalized signal having a single source probability above the first threshold can be used to initiate a signal sequence. After a signal sequence is initiated, any normalized signal having a single source probability above the second threshold can be added to the signal sequence.

The first threshold can be greater than the second threshold. For example, the first threshold can be 4% or 5% and the second threshold can be 2% or 3%. Thus, signals that are not necessarily reliable enough to initiate a signal sequence for an event can be considered for validating a possible event.

The event detection infrastructure can derive features of a signal grouping, such as, a signal sequence. Features of a signal sequence can include features of signals in the signal sequence, including single source probabilities. Features of a signal sequence can also include percentages, histograms, counts, durations, etc. derived from features of the signals included in the signal sequence. The event detection infrastructure can detect an event of interest to one or more parties from signal sequence features.

The event detection infrastructure can include one or more multi-source classifiers. A multi-source classifier can compute a multi-source probability for a signal sequence from features of the signal sequence. The multi-source probability can reflect a mathematical probability or approximation of a mathematical probability of an event (e.g., fire, accident, weather, police presence, etc.) actually occurring based on multiple normalized signals (e.g., the signal sequence). The multi-source probability can be assigned as an additional signal sequence feature. A multi-source classifier can be configured to compute a multi-source probability for a single event type or to compute a multi-source probability for each of a plurality of different event types. A multi-source classifier can compute a multi-source probability using artificial intelligence, machine learning, neural networks, etc.

A multi-source probability can change over time as a signal sequence ages or when a new signal is added to a signal sequence. For example, a multi-source probability for a signal sequence can decay over time. A multi-source probability for a signal sequence can also be recomputed when a new normalized signal is added to the signal sequence.

Multi-source probability decay can start after a specified period of time (e.g., 3 minutes) and decay can occur in accordance with a defined decay equation. In one aspect, a decay equation defines exponential decay of multi-source probabilities. Different decay rates can be used for different classes. Decay can be similar to radioactive decay, with different tau (i.e., mean lifetime) values used to calculate the “half life” of multi-source probability for different event types.

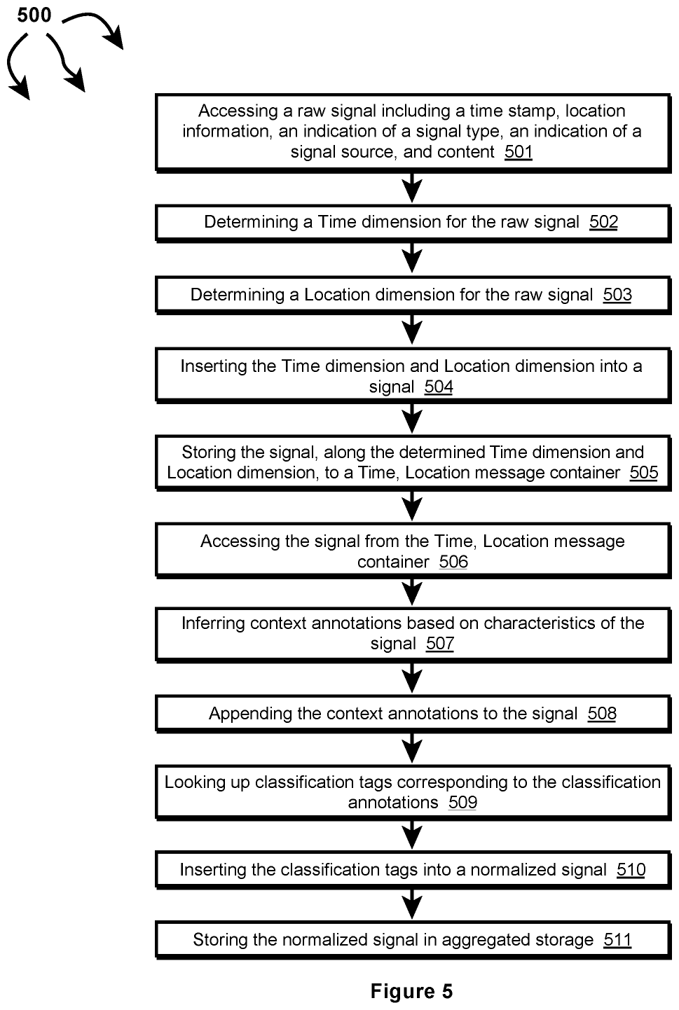

FIG. 7 illustrates an example computer architecture 700 that facilitates detecting an event from features derived from multiple signals. As depicted, computer architecture 700 further includes event detection infrastructure 103. Event infrastructure 103 can be connected to (or be part of) a network with signal ingestion modules 101. As such, signal ingestion modules 101 and event detection infrastructure 103 can create and exchange message related data over the network.

As depicted, event detection infrastructure 103 further includes evaluation module 706. Evaluation module 706 is configured to determine if features of a plurality of normalized signals collectively indicate an event. Evaluation module 706 can detect (or not detect) an event based on one or more features of one normalized signal in combination with one or more features of another normalized signal.

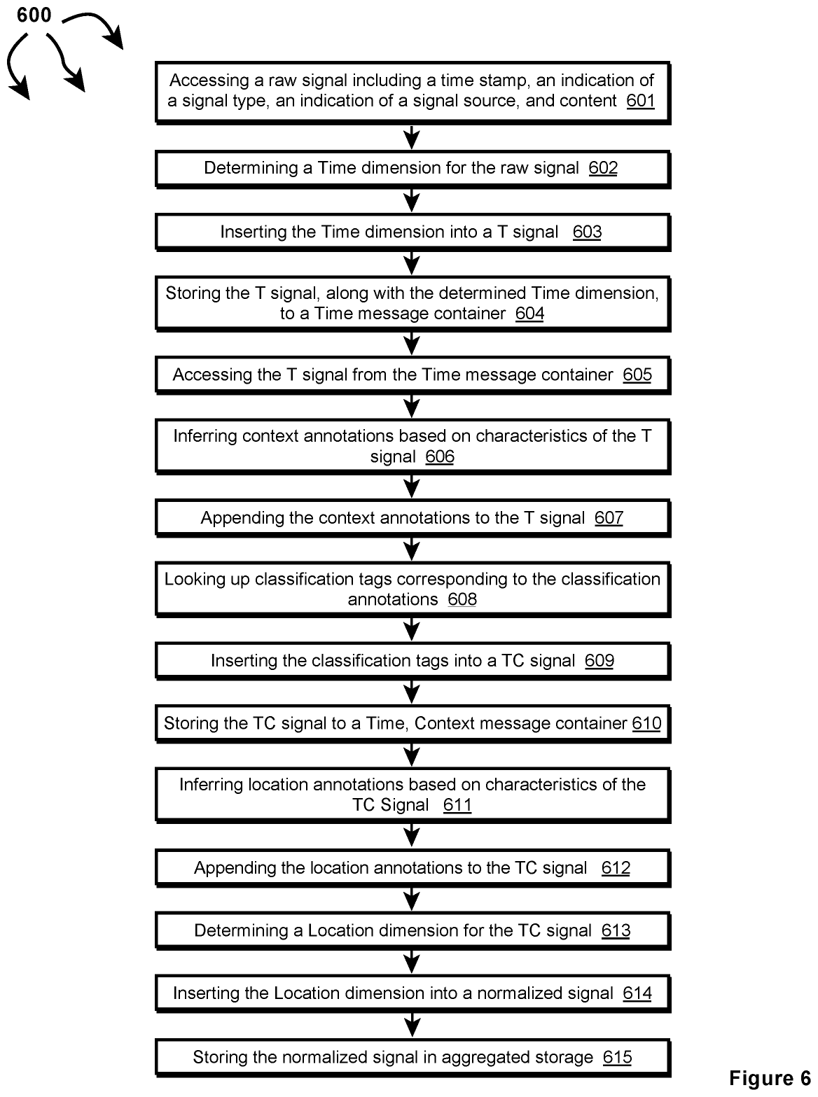

FIG. 8 illustrates a flow chart of an example method 800 for detecting an event from features derived from multiple signals. Method 800 will be described with respect to the components and data in computer architecture 700.

Method 800 includes receiving a first signal (801). For example, event detection infrastructure 103 can receive normalized signal 122B. Method 800 includes deriving first one or more features of the first signal (802). For example, event detection infrastructure 103 can derive features 701 of normalized signal 122B. Features 801 can include and/or be derived from time 123B, location 124B, context 126B, content 127B, type 128B, and source 129B. Event detection infrastructure 103 can also derive features 701 from one or more single source probabilities assigned to normalized signal 122B.

Normalized signal 122B can include an indication of an agency or jurisdiction and/or one or more agency codes. Features 701 can be derived from and/or can include the indication of an agency or jurisdiction and/or the one or more agency codes.

Method 800 includes determining that the first one or more features do not satisfy conditions to be identified as an event (803). For example, evaluation module 706 can determine that features 701 do not satisfy conditions to be identified as an event. That is, the one or more features of normalized signal 122B do not alone provide sufficient evidence of an event. In one aspect, one or more single source probabilities assigned to normalized signal 122B do not satisfy probability thresholds in thresholds 726.

Method 800 includes receiving a second signal (804). For example, event detection infrastructure 103 can receive normalized signal 122A. Method 800 includes deriving second one or more features of the second signal (805). For example, event detection infrastructure 103 can derive features 702 of normalized signal 122A. Features 702 can include and/or be derived from time 123A, location 124A, context 126A, content 127A, type 128A, and source 129A. Event detection infrastructure 103 can also derive features 702 from one or more single source probabilities assigned to normalized signal 122A.

Normalized signal 122A can include an indication of an agency or jurisdiction and/or one or more agency codes. Features 702 can be derived from and/or can include the indication of an agency or jurisdiction and/or the one or more agency codes. An indication of an agency or jurisdiction and/or one or more agency codes in features 702 may differ from an agency or jurisdiction and/or one or more agency codes in features 701.

Method 800 includes aggregating the first one or more features with the second one or more features into aggregated features (806). For example, evaluation module 706 can aggregate features 701 with features 702 into aggregated features 703 (which may include an indication of agency or jurisdiction and/or one or more agency codes). Evaluation module 706 can include an algorithm that defines and aggregates individual contributions of different signal features into aggregated features. Aggregating features 701 and 702 can include aggregating an event type single source probability assigned to normalized signal 122B with an event type signal source probability assigned to normalized signal 122A into a multisource probability for the event type.

Method 800 includes detecting an event from the aggregated features (807). For example, evaluation module 706 can determine that aggregated features 703 satisfy conditions to be detected as an event. Evaluation module 706 can detect event 724, such as, for example, a fire, an accident, a shooting, a protest, etc. based on satisfaction of the conditions.

In one aspect, conditions for event identification can be included in thresholds 726. Conditions can include threshold probabilities per event type. When a probability exceeds a threshold probability, evaluation module 706 can detect an event. A probability can be a single signal probability or a multisource (aggregated) probability. As such, evaluation module 706 can detect an event based on a multisource probability exceeding a probability threshold in thresholds 726.

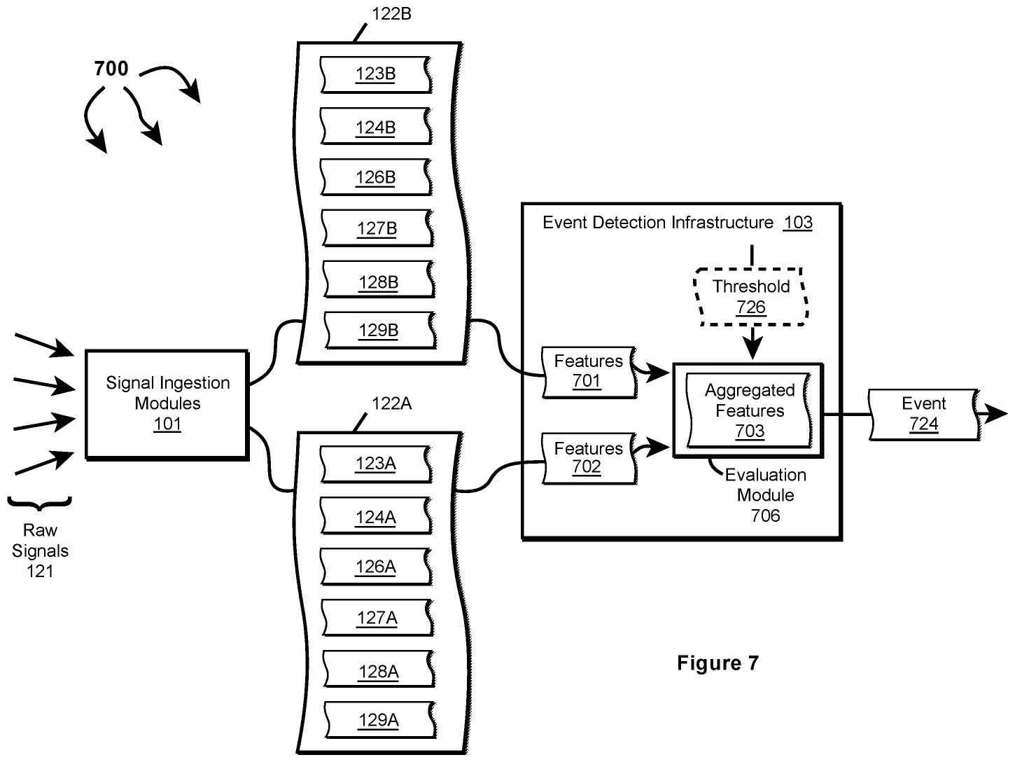

FIG. 9 illustrates an example computer architecture 900 that facilitates detecting an event from features derived from multiple signals. As depicted, event detection infrastructure 103 further includes evaluation module 206 and validator 204. Evaluation module 206 is configured to determine if features of a plurality of normalized signals indicate a possible event. Evaluation module 206 can detect (or not detect) a possible event based on one or more features of a normalized signal. Validator 204 is configured to validate (or not validate) a possible event as an actual event based on one or more features of another normalized signal.

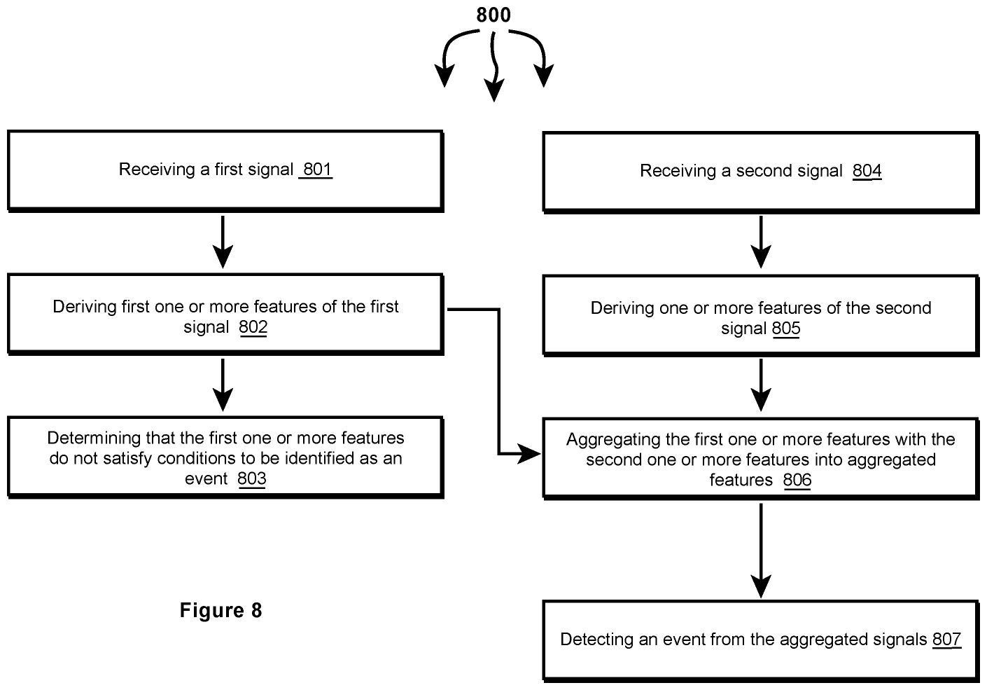

FIG. 10 illustrates a flow chart of an example method 1000 for detecting an event from features derived from multiple signals. Method 1000 will be described with respect to the components and data in computer architecture 900.

Method 1000 includes receiving a first signal (1001). For example, event detection infrastructure 103 can receive normalized signal 122B. Method 1000 includes deriving first one or more features of the first signal (1002). For example, event detection infrastructure 103 can derive features 901 of normalized signal 122B. Features 901 can include and/or be derived from time 123B, location 124B, context 126B, content 127B, type 128B, and source 129B. Event detection infrastructure 103 can also derive features 901 from one or more single source probabilities assigned to normalized signal 122B.

Normalized signal 122B can include an indication of an agency or jurisdiction and/or one or more agency codes. Features 901 can be derived from and/or can include the indication of an agency or jurisdiction and/or the one or more agency codes.

Method 1000 includes detecting a possible event from the first one or more features (1003). For example, evaluation module 706 can detect possible event 923 from features 901. Based on features 901, event detection infrastructure 103 can determine that the evidence in features 901 is not confirming of an event but is sufficient to warrant further investigation of an event type. In one aspect, a single source probability assigned to normalized signal 122B for an event type does not satisfy a probability threshold for full event detection but does satisfy a probability threshold for further investigation.

Method 1000 includes receiving a second signal (1004). For example, event detection infrastructure 103 can receive normalized signal 122A. Method 1000 includes deriving second one or more features of the second signal (1005). For example, event detection infrastructure 103 can derive features 902 of normalized signal 122A. Features 902 can include and/or be derived from time 123A, location 124A, context 126A, content 127A, type 128A, and source 129A. Event detection infrastructure 103 can also derive features 902 from one or more single source probabilities assigned to normalized signal 122A.

Normalized signal 122A can include an indication of an agency or jurisdiction and/or one or more agency codes. Features 902 can be derived from and/or can include the indication of an agency or jurisdiction and/or the one or more agency codes. An indication of an agency or jurisdiction and/or one or more agency codes in features 902 may differ from an agency or jurisdiction and/or one or more agency codes in features 901.

Method 1000 includes validating the possible event as an actual event based on the second one or more features (1006). For example, validator 704 can determine that possible event 923 in combination with features 902 provide sufficient evidence of an actual event. Validator 704 can validate possible event 923 as event 924 based on features 902. In one aspect, validator 704 considers a single source probability assigned to normalized signal 122B in view of a single source probability assigned to normalized signal 122A. Validator 704 determines that the signal source probabilities, when considered collectively satisfy a probability threshold for detecting an event.

Forming and Detecting Events from Signal Groupings

In general, a plurality of normalized (e.g., TLC) signals can be grouped together in a signal group based on spatial similarity and/or temporal similarity among the plurality of normalized signals and/or corresponding raw (non-normalized) signals. A feature extractor can derive features (e.g., percentages, counts, durations, histograms, etc.) of the signal group from the plurality of normalized signals. An event detector can attempt to detect events from signal group features. Features can include agency/jurisdiction indications, agency code language indications, one or more agency codes, etc.

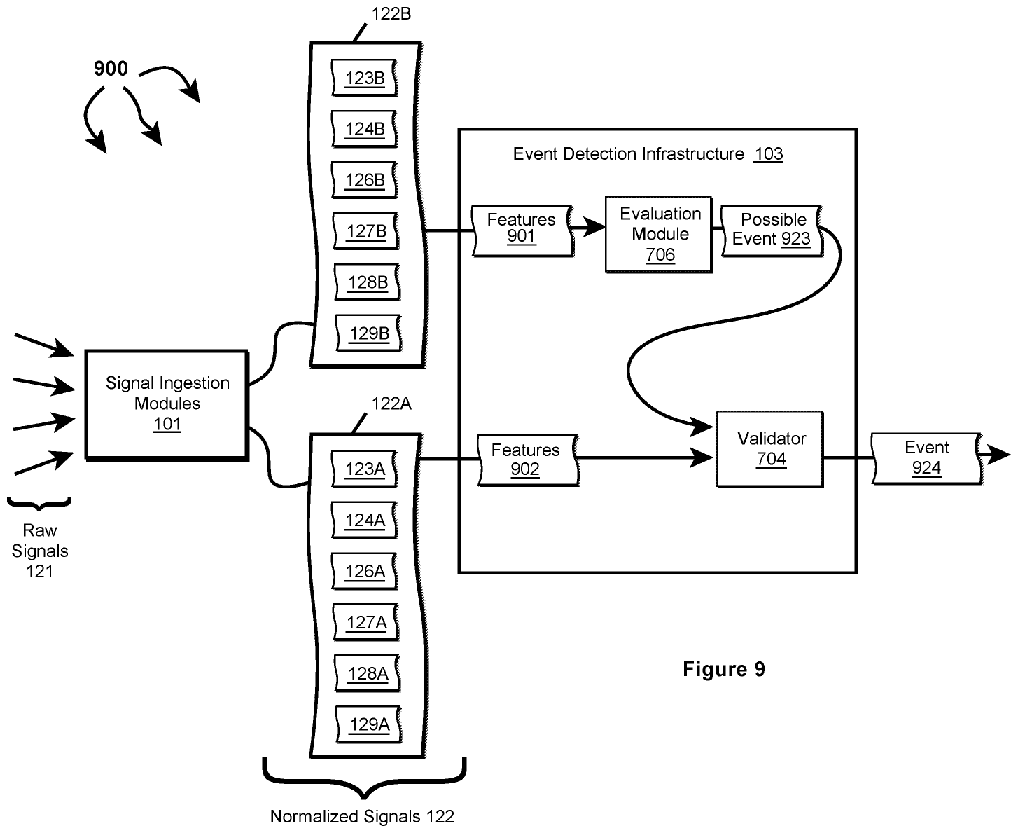

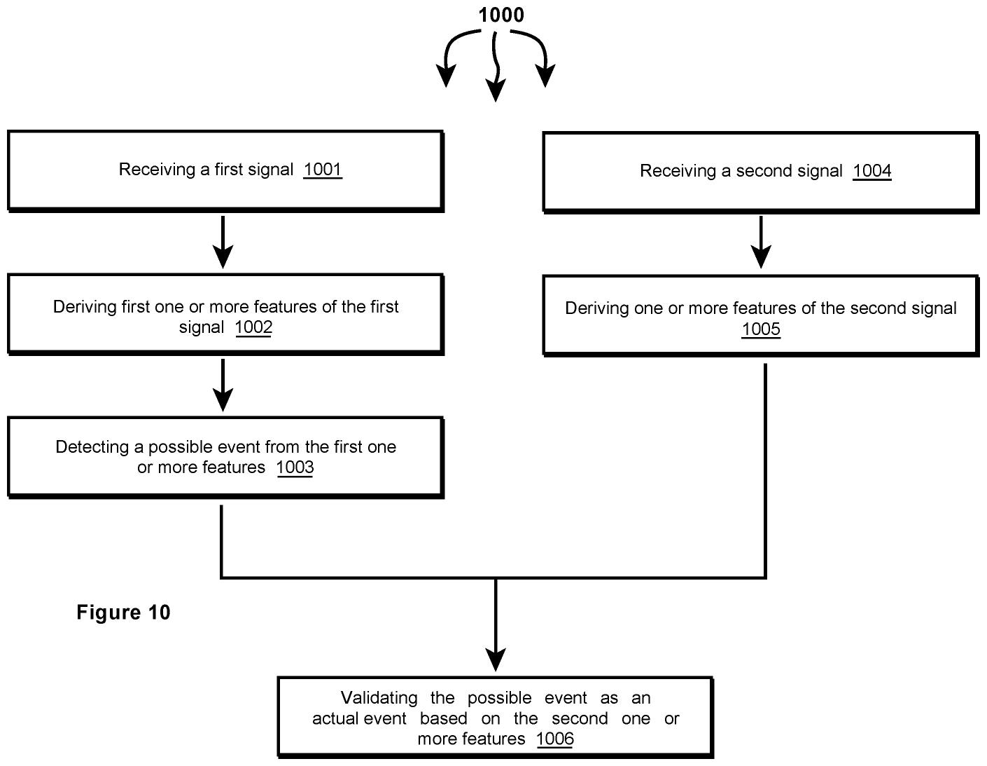

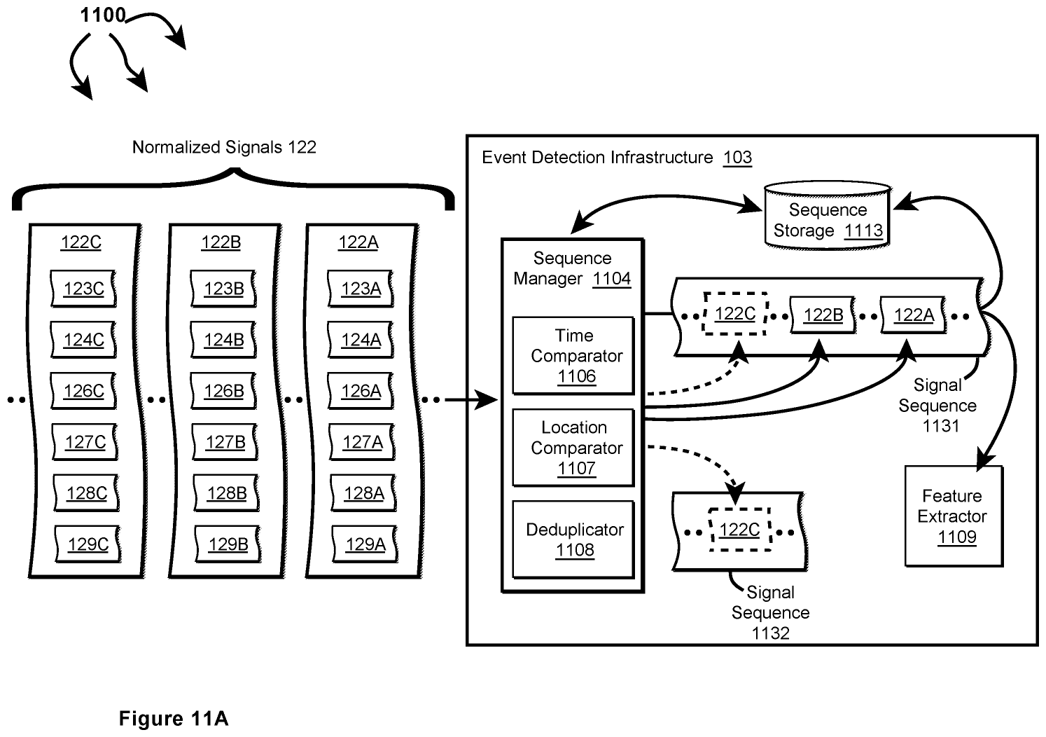

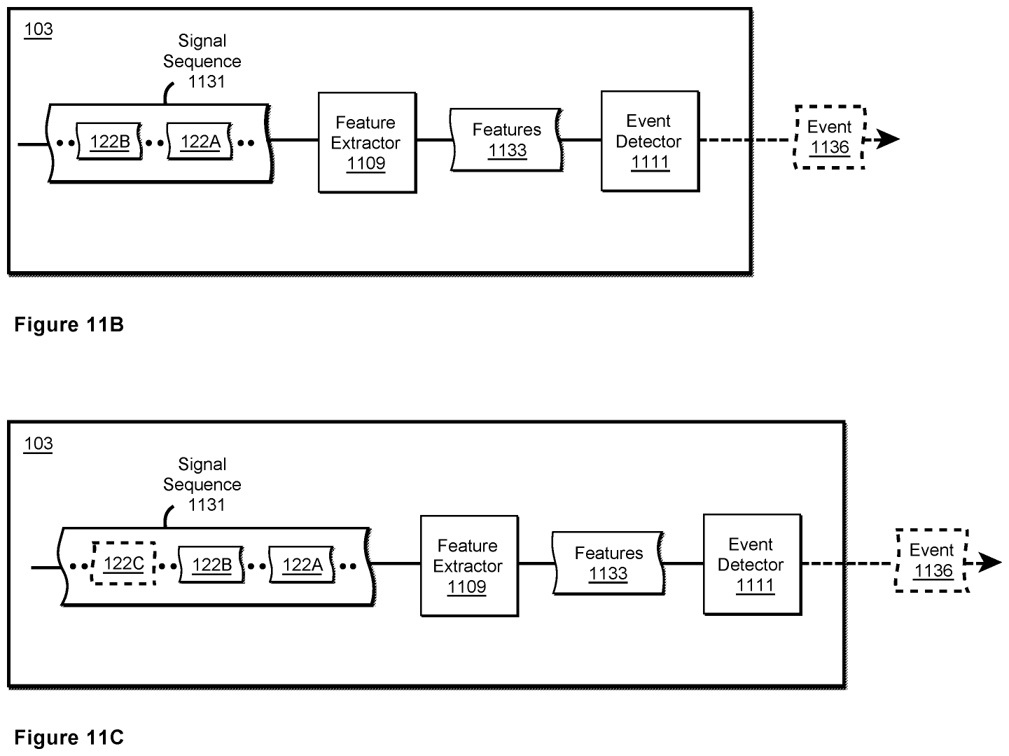

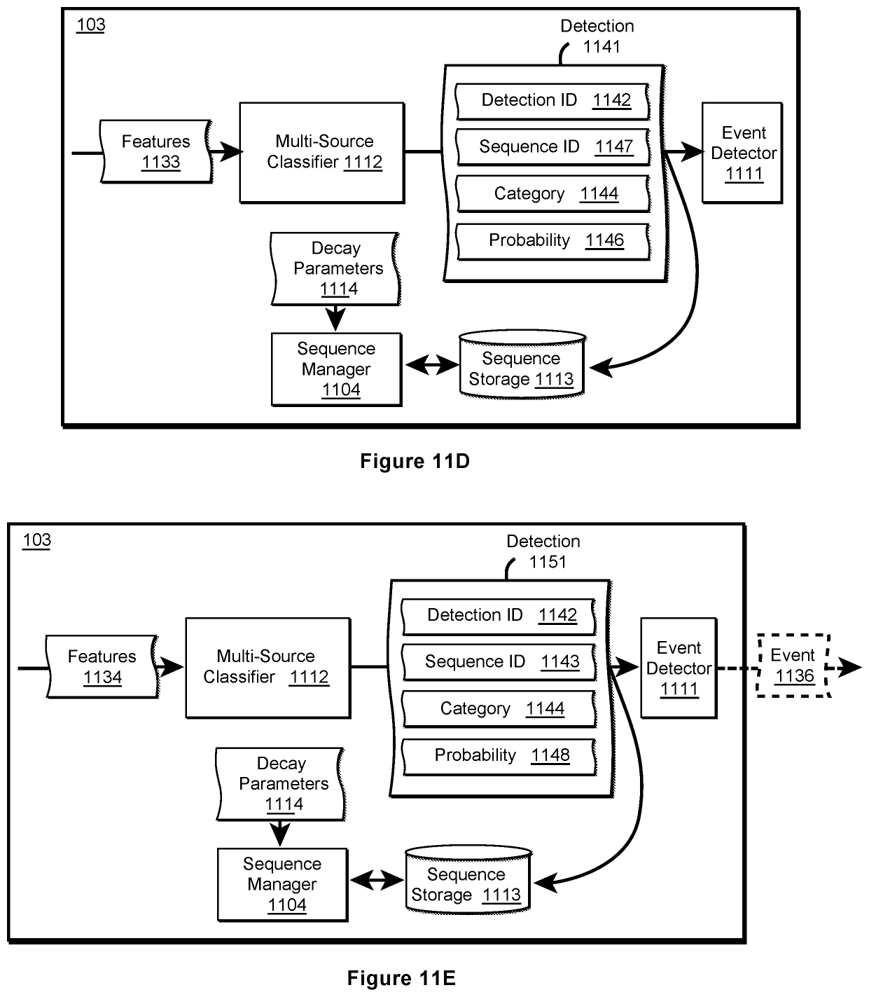

In one aspect, a plurality of normalized (e.g., TLC) signals are included in a signal sequence. Turning to FIG. 11A, event detection infrastructure 103 can include sequence manager 1104, feature extractor 1109, and sequence storage 1113. Sequence manager 11104 further includes time comparator 1106, location comparator 1107, and deduplicator 1108.

Time comparator 1106 is configured to determine temporal similarity between a normalized signal and a signal sequence. Time comparator 1106 can compare a signal time of a received normalized signal to a time associated with existing signal sequences (e.g., the time of the first signal in the signal sequence). Temporal similarity can be defined by a specified time period, such as, for example, 5 minutes, 10 minutes, 20 minutes, 30 minutes, etc. When a normalized signal is received within the specified time period of a time associated with a signal sequence, the normalized signal can be considered temporally similar to signal sequence.

Likewise, location comparator 1107 is configured to determine spatial similarity between a normalized signal and a signal sequence. Location comparator 1107 can compare a signal location of a received normalized signal to a location associated with existing signal sequences (e.g., the location of the first signal in the signal sequence). Spatial similarity can be defined by a geographic area, such as, for example, a distance radius (e.g., meters, miles, etc.), a number of geo cells of a specified precision, an Area of Interest (AoI), an agency, a jurisdiction, etc. When a normalized signal is received within the geographic area associated with a signal sequence, the normalized signal can be considered spatially similar to signal sequence.

Deduplicator 1108 is configured to determine if a signal is a duplicate of a previously received signal. Deduplicator 1108 can detect a duplicate when a normalized signal includes content (e.g., text, image, etc.) that is essentially identical to previously received content (previously received text, a previously received image, etc.). Deduplicator 1108 can also detect a duplicate when a normalized signal is a repost or rebroadcast of a previously received normalized signal. Sequence manager 604 can ignore duplicate normalized signals.

Sequence manager 1104 can include a signal having sufficient temporal and spatial similarity to a signal sequence (and that is not a duplicate) in that signal sequence. Sequence manager 1104 can include a signal that lacks sufficient temporal and/or spatial similarity to any signal sequence (and that is not a duplicate) in a new signal sequence. A signal can be encoded into a signal sequence as a vector using any of a variety of algorithms including recurrent neural networks (RNN) (Long Short Term Memory (LSTM) networks and Gated Recurrent Units (GRUs)), convolutional neural networks, or other algorithms.

Feature extractor 1109 is configured to derive features of a signal sequence from signal data contained in the signal sequence. Derived features can include a percentage of normalized signals per geohash, a count of signals per time of day (hours:minutes), a signal gap histogram indicating a history of signal gap lengths (e.g., with bins for 1 s, 5 s, 10 s, 1 m, 5 m, 10 m, 30 m), a count of signals per signal source, model output histograms indicating model scores, a sequent duration, count of signals per signal type, a number of unique users that posted social content, agency, jurisdiction, agency code language, one or more agency codes, etc. However, feature extractor 1109 can derive a variety of other features as well. Additionally, the described features can be of different shapes to include more or less information, such as, for example, gap lengths, provider signal counts, histogram bins, sequence durations, category counts, etc.

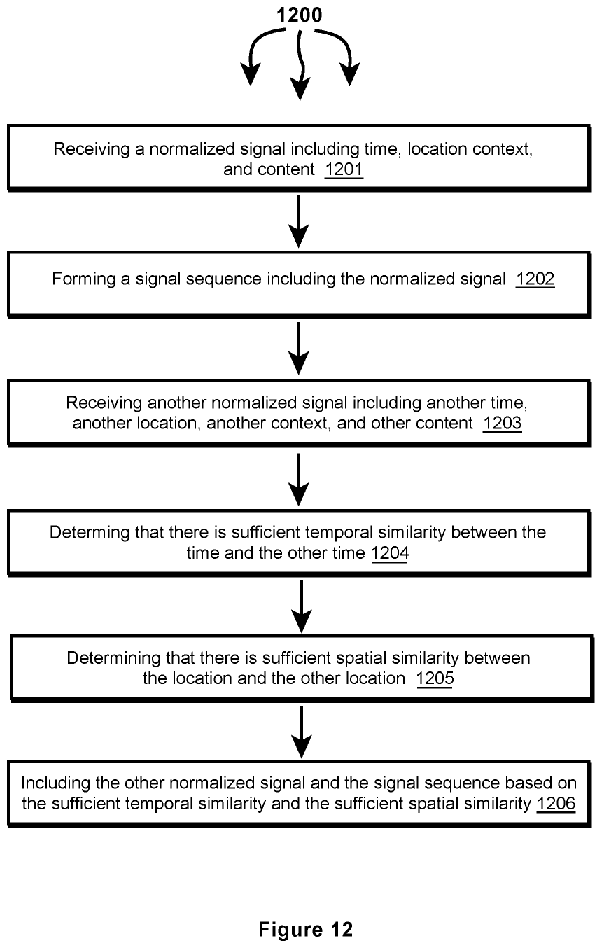

FIG. 12 illustrates a flow chart of an example method 1200 for forming a signal sequence. Method 1200 will be described with respect to the components and data in computer architecture 1100.

Method 1200 includes receiving a normalized signal including time, location, context, and content (1201). For example, sequence manager 1104 can receive normalized signal 122A. Method 1200 includes forming a signal sequence including the normalized signal (1202). For example, time comparator 1106 can compare time 123A to times associated with existing signal sequences. Similarly, location comparator 1107 can compare location 124A to locations associated with existing signal sequences. Time comparator 1206 and/or location comparator 1207 can determine that normalized signal 122A lacks sufficient temporal similarity and/or lacks sufficient spatial similarity respectively to existing signal sequences. Deduplicator 1108 can determine that normalized signal 122A is not a duplicate normalized signal. As such, sequence manager 1104 can form signal sequence 1131, include normalized signal 122A in signal sequence 1131, and store signal sequence 1131 in sequence storage 1113.

Method 1200 includes receiving another normalized signal including another time, another location, another context, and other content (1203). For example, sequence manager 1104 can receive normalized signal 122B.

Method 1200 includes determining that there is sufficient temporal similarity between the time and the other time (1204). For example, time comparator 1106 can compare time 123B to time 123A. Time comparator 1106 can determine that time 123B is sufficiently similar to time 123A. Method 1200 includes determining that there is sufficient spatial similarity between the location and the other location (1205). For example, location comparator 1107 can compare location 124B to location 124A. Location comparator 1107 can determine that location 124B has sufficient similarity to location 124A.

Method 1200 includes including the other normalized signal in the signal sequence based on the sufficient temporal similarity and the sufficient spatial similarity (1206). For example, sequence manager 1104 can include normalized signal 124B in signal sequence 1131 and update signal sequence 1131 in sequence storage 1113.

Subsequently, sequence manager 1104 can receive normalized signal 122C. Time comparator 1106 can compare time 123C to time 123A and location comparator 1107 can compare location 124C to location 124A. If there is sufficient temporal and spatial similarity between normalized signal 122C and normalized signal 122A, sequence manager 1104 can include normalized signal 122C in signal sequence 1131. On the other hand, if there is insufficient temporal similarity and/or insufficient spatial similarity between normalized signal 122C and normalized signal 122A, sequence manager 1104 can form signal sequence 1132. Sequence manager 1104 can include normalized signal 122C in signal sequence 1132 and store signal sequence 1131 in sequence storage 1113.

Turning to FIG. 11B, event detection infrastructure 103 further includes event detector 1111. Event detector 1111 is configured to determine if features extracted from a signal sequence are indicative of an event.

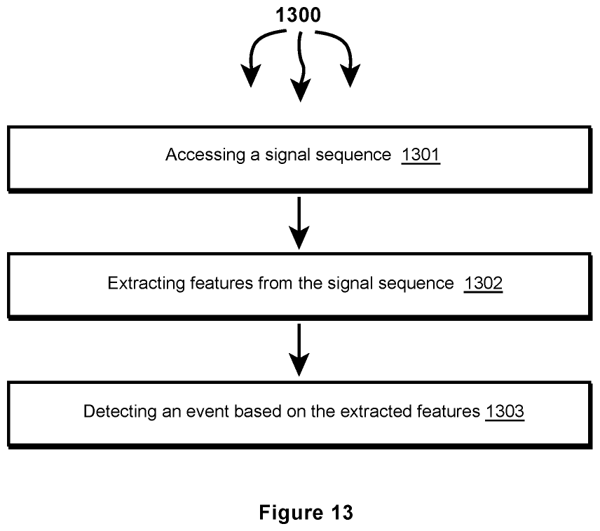

FIG. 13 illustrates a flow chart of an example method 1300 for detecting an event. Method 1300 will be described with respect to the components and data in computer architecture 1100.

Method 1300 includes accessing a signal sequence (1301). For example, feature extractor 1109 can access signal sequence 1131. Method 1300 includes extracting features from the signal sequence (1302). For example, feature extractor 1109 can extract features 1133 from signal sequence 1131. Method 1300 includes detecting an event based on the extracted features (1303). For example, event detector 1111 can attempt to detect an event from features 1133. In one aspect, event detector 1111 detects event 1136 from features 1133. In another aspect, event detector 1111 does not detect an event from features 1133.

Turning to FIG. 11C, sequence manager 1104 can subsequently add normalized signal 122C to signal sequence 1131 changing the signal data contained in signal sequence 1131. Feature extractor 1109 can again access signal sequence 1131. Feature extractor 1109 can derive features 1134 (which differ from features 1133 at least due to inclusion of normalized signal 122C) from signal sequence 1131. Event detector 1111 can attempt to detect an event from features 1134. In one aspect, event detector 1111 detects event 1136 from features 1134. In another aspect, event detector 1111 does not detect an event from features 1134.

In a more specific aspect, event detector 1111 does not detect an event from features 1133. Subsequently, event detector 1111 detects event 1136 from features 1134.

An event detection can include one or more of a detection identifier, a sequence identifier, and an event type (e.g., accident, hazard, fire, traffic, weather, etc.).

A detection identifier can include a description and features. The description can be a hash of the signal with the earliest timestamp in a signal sequence. Features can include features of the signal sequence. Including features provides understanding of how a multisource detection evolves over time as normalized signals are added. A detection identifier can be shared by multiple detections derived from the same signal sequence.

A sequence identifier can include a description and features. The description can be a hash of all the signals included in the signal sequence. Features can include features of the signal sequence. Including features permits multisource detections to be linked to human event curations. A sequence identifier can be unique to a group of signals included in a signal sequence. When signals in a signal sequence change (e.g., when a new normalized signal is added), the sequence identifier is changed.

In one aspect, event detection infrastructure 103 also includes one or more multisource classifiers. Feature extractor 1109 can send extracted features to the one or more multisource classifiers. Per event type, the one or more multisource classifiers compute a probability (e.g., using artificial intelligence, machine learning, neural networks, etc.) that the extracted features indicate the type of event. Event detector 611 can detect (or not detect) an event from the computed probabilities.

For example, turning to FIG. 11D, multi-source classifier 1112 is configured to assign a probability that a signal sequence is a type of event. Multi-source classifier 1112 formulate a detection from signal sequence features. Multi-source classifier 1112 can implement any of a variety of algorithms including: logistic regression, random forest (RF), support vector machines (SVM), gradient boosting (GBDT), linear, regression, etc.

For example, multi-source classifier 1112 (e.g., using machine learning, artificial intelligence, neural networks, etc.) can formulate detection 1141 from features 1133. As depicted, detection 1141 includes detection ID 1142, sequence ID 1143, category 1144, and probability 1146. Detection 1141 can be forwarded to event detector 1111. Event detector 1111 can determine that probability 1146 does not satisfy a detection threshold for category 1144 to be indicated as an event. Detection 1141 can also be stored in sequence storage 1113.

Subsequently, turning to FIG. 11E, multi-source classifier 1112 (e.g., using machine learning, artificial intelligence, neural networks, etc.) can formulate detection 1151 from features 1134. As depicted, detection 151 includes detection ID 1142, sequence ID 1147, category 1144, and probability 1148. Detection 1151 can be forwarded to event detector 1111. Event detector 1111 can determine that probability 1148 does satisfy a detection threshold for category 1144 to be indicated as an event. Detection 1141 can also be stored in sequence storage 1113. Event detector 1111 can output event 1136.

As detections age and exhibit declining accuracy (i.e., may not be True Positives), the probability declines that signals are “True Positive” detections of actual events. As such, a multi-source probability for a signal sequence, up to the last available signal, can be decayed over time. When a new signal comes in, the signal sequence can be extended by the new signal. The multi-source probability is recalculated for the new, extended signal sequence, and decay begins again.

In general, decay can also be calculated “ahead of time” when a detection is created and a probability assigned. By pre-calculating decay for future points in time, downstream systems do not have to perform calculations to update decayed probabilities. Further, different event classes can decay at different rates. For example, a fire detection can decay more slowly than a crash detection because these types of events tend to resolve at different speeds. If a new signal is added to update a sequence, the pre-calculated decay values may be discarded. A multi-source probability can be re-calculated for the updated sequence and new pre-calculated decay values can be assigned.

Multi-source probability decay can start after a specified period of time (e.g., 3 minutes) and decay can occur in accordance with a defined decay equation. Thus, modeling multi-source probability decay can include an initial static phase, a decay phase, and a final static phase. In one aspect, decay is initially more pronounced and then weakens. Thus, as a newer detection begins to age (e.g., by one minute) it is more indicative of a possible “false positive” relative to an older event that ages by an additional minute.

In one aspect, a decay equation defines exponential decay of multi-source probabilities. Different decay rates can be used for different classes. Decay can be similar to radioactive decay, with different tau values used to calculate the “half life” of multi-source probability for a class. Tau values can vary by event type.

In FIGS. 11D and 11E, decay for signal sequence 1131 can be defined in decay parameters 1114. Sequence manager 1104 can decay multisource probabilities computed for signal sequence 1131 in accordance with decay parameters 1114.

The components and data depicted in FIGS. 7-13 can be integrated with and/or can interoperate with one another to detect events. For example, event detection infrastructure 103, evaluation module 206 and/or validator 204 can include and/or interoperate with one or more of: sequence storage, a sequence manager, a feature extractor, multi-source classifiers, or an event detector. Event detection can be based on agencies, jurisdictions, agency code languages, and agency codes.

Agency Code Mapping

In general, aspects of the invention provide mechanisms to translate between different agency code languages. Multiple disparate systems, each using different agency code languages, can be mapped and synthesized in the cloud. Different agency code languages can be intuitively translated at live user interface. A language key can allow agencies to seamlessly translate from a native code language to a common language.

In one aspect, per agency, a master (e.g., Comma-Separated Values (CSV)) file maps between an agency's code language and a common language. Upon ingestion (e.g., at signal ingestion modules 101), a raw signal may include one or more agency codes associated with an agency. The one or more agency codes can be mapped to both: (a) one or more corresponding classification tags (e.g., by classification tag service 306) and (b) one or more corresponding meanings in the common language (e.g., by reference to the master file). Meanings in the common language can then be mapped to agency codes of other agencies. Accordingly, an agency code in one agency code language can be mapped to a common language meaning and subsequently the common language meaning can be mapped to an agency code of another (different) agency. The combination of mapping and subsequent mapping can facilitate more efficient and effective interagency communication.

An onboarding process can be used per agency. When an agency is onboarded their different agency codes and corresponding meanings can be mapped to a master file. The master file can be uploaded for ingestion. In one aspect, an onboarding tool is used to replace and/or in combination with a master file.

When onboarded, an agency may have various language options available for them. Default language options can include presentation in a source code language, a common language, and a native code language. Translation to certain agency codes can be feature-flagged depending on a user and their level of access. For example, Utah's Office of the AG may have the entire state of Utah's languages to choose from, whereas Salt Lake City Police Dept may only have city-wide languages to choose from.

Translation between some jurisdictions may not be a 1 to 1 mapping (e.g., may be N to 1 or 1 to N). However, ingestion and translation modules can account for and resolve inconsistencies to facilitate appropriate representation of incident meanings in different agency code languages and in the common language.

Translation options can be located on a navigation bar within a user interface. A drop-down menu of options can allow for a user to select which language (e.g., from among a source code language, a common language, or a native code language) to display on the UI for detected events. When a user selects one of the language options presented to them from the drop-down menu, the translation can occur essentially in real-time on the UI. An agency code meaning in the selected language can be displayed in the place of a title string. The translation can occur live, meaning everything updates on the UI that is visible essentially as soon as user changes their language. Everything else can adapt to new language preference as it becomes visible as well. A translation selection can persist upon login/logout or until user decides to change it to other options.

Drop-down lists may be adaptable and can be updated as agency codes are acquired from additional agencies (e.g., when an agency is onboarded).

Agency code selection can be titled with the agency's name. For example, Salt Lake City Police Dept's language can be presented as ‘Salt Lake City Police Dept’ within a navigation bar on the UI. Since each agency may use combination of different agency codes, each agency code language can be titled by the agency's name to mitigate confusion. A common language can be similarly presented.

In some aspects, event detection infrastructure 103 detects an event (e.g., event 135) based on one or more agency codes associated with a source code language corresponding to agency or jurisdiction. Event notification 116 determines that the event is relevant to another agency and/or jurisdiction. Event notification 116 refers to a first mapping that maps the source code language to a common language. Event notification 116 maps the one or more agency codes to meanings in the common language. Event notification 116 refers to a second mapping that maps the common language to a native code language of the other agency/jurisdiction.

Event notification 116 presents the event to the other agency/jurisdiction along with one or more of: the meaning of the one or more agency codes in the common language or one or more agency codes in the native code language.

The present described aspects may be implemented in other specific forms without departing from its spirit or essential characteristics. The described aspects are to be considered in all respects only as illustrative and not restrictive. The scope is, therefore, indicated by the appended claims rather than by the foregoing description. All changes which come within the meaning and range of equivalency of the claims are to be embraced within their scope.

1. A method comprising:
ingesting a raw signal including a time stamp, an indication of a signal type, an indication of a signal source, and one or more agency codes;
normalizing the raw signal into a normalized signal by reducing the dimensionality of the raw signal, including:
determining a time dimension associated with the raw signal from the time stamp;
determining a location dimension associated with the raw signal from one or more of: location information included in the raw signal or location annotations inferred from characteristics of the raw signal;
determining a context dimension associated with the raw signal based on the one or more agency codes, including:
calculating a probability of a real-world event type and probability details, the probability details indicating one or more of: a probabilistic model used to calculate the probability or features of the raw signal considered in calculating the probability;
including the time dimension, the location dimension, and the context dimension, including the probability and probability details, along with the indication of the signal type, the indication of the signal source, and the content in the normalized signal; and
detecting an occurring real-world event of the real-world event type from the time dimension, location dimension, and context dimension included in the normalized signal.

2. The method of claim 1, further comprising:
notifying one or more entities about the real-world event.

3. The method of claim 1, further comprising indicating the probability details in a hash field.

4. The method of claim 3, further comprising deriving the hash field.

5. The method of claim 2, wherein detecting an occurring real-world event comprises detecting one of: a fire, police presence, an accident, a natural disaster, weather, a shooter, a concert, or a protest; and
wherein notifying one or more entities about the real-world event comprises notifying one of: a person, a business entity, or a governmental agency.

6. The method of claim 1, wherein ingesting a raw signal comprises ingesting agency radio communication.

7. The method of claim 6, wherein normalizing the raw signal comprises re-encoding the agency radio communication into normalized data having lower dimensionality by applying a transdimensionality transform defined in a Time, Location, Context (“TLC”) dimensional model to the agency radio communication.

8. A method comprising:
receiving a first Time, Location, Context (TLC) normalized signal including a first time dimension, a first location dimension, and a first context dimension, the first context dimension including a first single source probability representing at least a first approximate probability of a real-world event of a specified event type;
deriving first one or more features from the first TLC normalized signal including from the first single source probability, the first one or more features including one or more agency codes;
determining that the first one or more features, including the first single source probability and the one or more agency codes, provide insufficient evidence to be identified as the real-world event of the specified event type;
receiving a second Time, Location, Context (TLC) normalized signal including a second time dimension, a second location dimension, and a second context dimension, the second context dimension including a second single source probability representing at least a second approximate probability that the real-world event of the specified event type;
deriving second one or more features from the second TLC normalized signal including from the second signal source probability;
aggregating the first single source probability and the second single source probability into a multisource probability; and
detecting the real-world event from evidence provided by the multisource probability, including the multisource probability exceeding a threshold probability associated with the event type.

9. The method of claim 8, wherein determining that the first one or more features, including the first single source probability, provide insufficient evidence to be identified as the real-world event comprise detecting a possible event from the first one or more features; and
wherein detecting the real-world event from evidence provided by the multisource probability comprises validating the possible event as the real-world event based on the second one or more features.

10. The method of claim 8, further comprising:
including the first TLC normalized signal in a signal sequence;
determining that the second TLC normalized signal has sufficient temporal similarity to the first TLC normalized signal;
determining that the second TLC normalized signal has sufficient spatial similarity to the first TLC normalized signal; and
including the second normalized signal in the signal sequence.

11. The method of claim 10, wherein aggregating the first single source probability with the second single source probability comprises deriving features of the signal sequence from the first one or more features and the second one or more features.

12. The method of claim 11, wherein deriving features of the signal sequence comprises deriving one or more of: a percentage, a count, a histogram, or a duration.

13. The method of claim 8, wherein the first TLC normalized signal corresponds to one of: a social post with geographic content, a social post without geographic content, an image from a camera feed, a 911 call, weather data, IoT device data, satellite data, satellite imagery, a sound clip from a listening device, data from air quality sensors, a sound clip from radio communication, crowd sourced traffic information, or crowd sourced road information.

14. The method of claim 13, wherein the second TLC normalized signal corresponds to a different one of: a social post with geographic content, a social post without geographic content, an image from a traffic camera feed, a 911 call, weather data, IoT device data, satellite data, satellite imagery, a sound clip from a listening device, data from air quality sensors, a sound clip from radio communication, crowd sourced traffic information, or crowd sourced road information.
